(19) United States
(12) Patent Application Publication
(10) Pub. No.: US 2026/0299745 A1
(43) Pub. Date: Oct. 1, 2026

(54) INPUT AND OUTPUT APPARATUS, INFORMATION PROCESSING APPARATUS, INFORMATION PROCESSING METHOD, RECORDING MEDIUM, AND INFORMATION PROCESSING SYSTEM

(71) Applicant: Naoki MOTOHASHI, Kanagawa (JP)

(72) Inventor: Naoki MOTOHASHI, Kanagawa (JP)

(21) Appl. No.: 19/478,657

(22) PCT Filed: May 31, 2024
(86) PCT No.: PCT/IB2024/055324

§ 371 Date: Oct. 24, 2025

(30) Foreign Application Priority Data
Jun. 19, 2023 (JP) 2023-100172

(51) Int. Cl. G06F 3/04815; G06F 3/14

(52) U.S. Cl. CPC G06F 3/04815; G06F 3/14

(57) ABSTRACT

An input and output apparatus includes a display control unit to display a three-dimensional shape on a display and a reception unit to receive an operation on the three-dimensional shape displayed on the display. The display control unit further displays, on the display, information corresponding to the three-dimensional shape and the operation based on the operation performed on the three-dimensional shape.

### TECHNICAL FIELD

The present disclosure relates to an input and output apparatus, an information processing apparatus, an information processing method, a recording medium, and an information processing system.

### BACKGROUND ART

Patent Literature (PTL) 1 discloses a technique for extracting a matching object to be matched with three-dimensional model data from point cloud data including depth information, and matching the three-dimensional model data with the matching object to identify an object matching portion in the three-dimensional model data by using machine learning. Further, PTL 1 discloses a technique for identifying a target position in a building based on information on the object matching portion in the three-dimensional model data and the depth information of the point cloud data.

### CITATION LIST

### Patent Literature

PTL 1

Japanese U.S. Pat. No. 7,113,611

### SUMMARY OF INVENTION

### Technical Problem

Appropriate information may not be provided to a user who performs an operation on a three-dimensional shape.

### Solution to Problem

According to an aspect of the present disclosure, an input and output apparatus includes a display control unit to display a three-dimensional shape on a display and a reception unit to receive an operation on the three-dimensional shape displayed on the display. The display control unit further displays, on the display, information corresponding to the three-dimensional shape and the operation based on the operation performed on the three-dimensional shape.

According to an aspect of the present disclosure, an information processing apparatus includes a transmission unit to transmit, to an input and output apparatus, display screen information representing a display screen for displaying a three-dimensional shape, and a reception unit to receive input information transmitted from the input and output apparatus.

The input information indicates that an operation has been performed on the three-dimensional shape displayed on the display screen. The transmission unit transmits, to the input and output apparatus, information corresponding to the three-dimensional shape and the operation based on the input information.

According to an aspect of the present disclosure, an information processing method includes displaying a three-dimensional shape on a display, receiving an operation on the three-dimensional shape displayed on the display, and displaying information corresponding to the three-dimensional shape and the operation based on the operation on the three-dimensional shape displayed on the display.

According to an aspect of the present disclosure, a recording medium storing computer-readable code for controlling a computer system to carry out a method. The method includes displaying a three-dimensional shape on a display, receiving an operation on the three-dimensional shape displayed on the display, and displaying information corresponding to the three-dimensional shape and the operation based on the operation on the three-dimensional shape displayed on the display.

According to an aspect of the disclosure, an information processing system includes an input and output apparatus and an information processing apparatus connected to the input and output apparatus via a network. The input and output apparatus includes a display control unit to display a three-dimensional shape on a display, a reception unit to receive an operation on the three-dimensional shape displayed on the display, and a transmission unit to transmit, to the information processing apparatus, input information indicating that the operation has been performed on the three-dimensional shape displayed on the display. The information processing apparatus includes a reception unit to receive the input information transmitted from the input and output apparatus and a transmission unit to transmit, to the input and output apparatus, information corresponding to the three-dimensional shape and the operation based on the input information. The input and output apparatus further includes a reception unit to receive the information transmitted from the information processing apparatus, and the display control unit displays the information on the display.

### Advantageous Effects of Invention

According to one or more embodiments, appropriate information corresponding to a three-dimensional shape and an operation on the three-dimensional shape can be provided to a user who operates the three-dimensional shape.

### BRIEF DESCRIPTION OF DRAWINGS

A more complete appreciation of embodiments of the present disclosure and many of the attendant advantages and features thereof can be readily obtained and understood from the following detailed description with reference to the accompanying drawings.

FIG. 1 is a diagram illustrating an overall configuration of a three-dimensional shape generation system according to some embodiments.

FIG. 2 is a block diagram illustrating a hardware configuration of each of a terminal apparatus and a server according to some embodiments.

FIG. 3 is a block diagram illustrating a functional configuration of the three-dimensional shape generation system according to the present embodiment.

FIG. 4 is a conceptual diagram illustrating a setting information management table according to some embodiments.

FIGS. 5A and 5B (FIG. 5) are conceptual diagrams illustrating a virtual space management table according to some embodiments.

FIG. 6 is a sequence diagram illustrating a virtual space generation process according to some embodiments.

FIG. 7 is a sequence diagram illustrating a virtual space operation process according to some embodiments.

FIG. 8 is a diagram illustrating a setting screen according to some embodiments.

FIG. 9 is a flowchart of a three-dimensional shape generation process according to some embodiments.

FIGS. 10A and 10B (FIG. 10) are diagrams illustrating registration processing according to some embodiments.

FIG. 11 is a diagram illustrating noise removal processing according to some embodiments.

FIG. 12 is a diagram illustrating segmentation processing according to some embodiments.

FIGS. 13A to 13C (FIG. 13) are diagrams illustrating model comparison and replacement processing according to some embodiments.

FIG. 14 is a diagram illustrating an operation screen according to some embodiments.

FIG. 15A and FIG. 15B (FIG. 15) are flowcharts each illustrating a virtual space operation process according to some embodiments.

FIGS. 16A to 16H (FIG. 16) are diagrams each illustrating a virtual space screen according to some embodiments.

FIGS. 17A to 17H (FIG. 17) are diagrams each illustrating a virtual space screen according to some embodiments.

FIGS. 18A and 18B (FIG. 18) are diagrams each illustrating still a virtual space screen according to some embodiments.

FIG. 19 is a diagram illustrating a virtual space screen according to some embodiments.

FIG. 20 is a diagram illustrating a virtual space screen according to some embodiments.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise. In the fields of civil engineering and architecture, the implementation of building information modeling (BIM)/construction information modeling (CIM) has been promoted for coping with, for example, the demographic shift towards an older population and enhancing labor efficiency and productivity.

BIM is a solution that involves utilizing a database of buildings, in which attribute data such as cost, finishing details, and management information, is added to a three-dimensional (3D) digital model of a building. This model is created on a computer and utilized throughout every stage of the architectural process, including design, construction, and maintenance. The three-dimensional digital model is referred to as a 3D model in the following description.

CIM is a solution that has been proposed for the field of civil engineering (covering general infrastructure such as roads, electricity, gas, water supply, etc. ,) following BIM that has been advancing in the field of architecture. CIM is being pursued, similar to BIM, to aim for efficiency and advancement in a series of construction production systems by sharing information through centralized 3D models among participants.

A matter of concern for promoting BIM/CIM implementation is how to easily construct a 3D model of a building or a public facility.

When a structure is constructed from the beginning, for example, 3D Computer-Aided Design (3D CAD) software can be used to model a completed structure from the beginning, so that BIM/CIM can be easily introduced. On the other hand, regarding the existing buildings, there is a case where, for example, the original design drawings are not preserved, or the existing building is different from the design drawing due to modification, and the barriers to the BIM/CIM implementation are high. Such BIM implementation for an existing building is called “As-Build BIM”, and is an issue for promoting the BIM/CIM implementation going forward.

As a way to achieve the As-Build BIM, a workflow of performing spatial measurement using a laser scanner (referred to as an LS in the following description of the present embodiment) and creating a CAD model from point cloud data obtained by the spatial measurement. Since a space has been restored by measuring with photographs, a tape measure, etc., and sketching in the related art, a large amount of work cost is generated. However, the efficiency of this work is significantly increased by introducing the LS.

In the Ad-Build using the LS, modeling is facilitated, however, a work of point cloud processing, which has not been present in the known art, newly arises. In typical point cloud processing, multipoint measurement using LS, alignment of individual point clouds, generation of a merged point cloud, and removal of unnecessary points (an unnecessary point cloud) such as noise are performed on a point cloud, and then the point cloud is converted into a 3D CAD model conversion” is performed.

These processes are performed using an automatic model creation function of point cloud processing software that is commercially available. However, when objects of different categories such as a pipe, a desk, and a person are present in the same space, that is, in the same point cloud, if three-dimensional shapes of the objects of the different categories are to be generated at once, the accuracy may be insufficient or the processing time may be long.

On the other hand, when the three-dimensional shape of an object of a single category is generated, it takes time and effort to repeat the generation for the number of required categories.

According to an embodiment, a three-dimensional shape is appropriately generated with the accuracy desired by a user without taking processing time and effort more than necessary.

There is another concern about how to utilize the constructed BIM/CIM.

In particular, the 3D space restored by BIM/CIM can be used for other works such as maintenance and site investigation as well as for design and construction. In addition to using the 3D space as a design drawing, for example, the 3D space can be used to leave a record on the 3D space or to share information on the 3D space between the users. At this time, the amount of information of 3D is greater than that of 2D, and thus it is difficult for a user who views the 3D for the first time to handle the 3D.

Further, since work performed on a digital basis can be recorded as a log, if tacit knowledge can be extracted based on the work, the tacit knowledge can be effectively used for technical transfer from an expert to a young person. This is expected to lead to front loading of business, human resource development, etc.

On the other hand, the standard for, for example, how to support and how to present information has not been determined, and creating a mechanism for facilitating the utilization of a 3D space is desired.

According to an embodiment, information on a worker's gaze and a search result based on a knowledge base are referred to and then an unobserved area related to the searched knowledge is displayed on a screen. This prevents an oversight. As a result, the information collected from the experienced persons in the past is recorded in the knowledge base, and the technical transfer can be achieved.

In the present embodiment, when the user performs an operation on the 3D space, information related to the operation is provided as a recommendation by the following two methods.

### Recommendation Method Without Learning Operation

Predefined information or information extracted by data analysis of a past work log is given in advance to an object or a position on a 3D space, and when a user performs an operation such as visual recognition, click, or touch on a predetermined object or position, the information is provided as a recommendation.

### Recommendation Method by Learning Operation

When operating a 3D space, the user selects information to be presented. The preference of the user is extracted by recording and learning the selection history in the knowledge base. When an operation is performed on the space, related information is extracted from the knowledge base and provided as a recommendation to the user who is operating the information processing apparatus. For example, information that is easy for the user to select or information that is likely to be preferred by the user by analogizing from the selection history is preferentially provided as a recommendation.

In order to facilitate the utilization of a 3D space, it is desirable to set various conditions for information to be provided as a recommendation and a timing to present the information. Various conditions related to the work common in the present description are described below.

Information is provided as a recommendation to the user by combining two or more of the following conditions. By setting the various conditions, detailed recommendation can be performed, and unnecessary information such as noise can be reduced. However, it is not necessary to set all the conditions, and any item for the conditions can be set as appropriate.

### 1. Method of Designating Position

When a 3D space is operated, a method of associating information to be provided as a recommendation and a position for the recommendation can be used. For example, a method of associating absolute coordinates in a space with information can be used. In response to any one of the “operations” performed by the user for the absolute position, to the associated information is provided as a recommendation. The “operations” are described below.

As another example of a position designation method, a method of directly giving a position to an object in a space or a method of designating a position based on a relative positional relationship between objects can be considered. The latter is an effective designation method when information based on the relationship between objects is given, for example, when the information A is given to an intermediate position between a table and a chair.

### 2. Recommendation Timing

Even in the same space, it is desirable to switch the recommendation timing according to a temporal change. For example, a time of year such as a time and a season can be used. Further, temporal changes in the use of a space can be used. For example, in the case of a work process in the construction industry, the work process starts with an initial site investigation, and proceeds to detailed site investigation, design, construction, and maintenance, and the situation of the space and the work performed in the space changes over time accordingly.

### 3. Recommendation Target

This item focuses on the user who uses the space. Even in the same space, it is assumed that information to be requested changes depending on the users who use the space.

For example, the personal information of the user such as the name, age, date of birth, sex, address, affiliation, and mail address of the user may be used. Further, in the case of architecture, for example, the user's roles such as a site supervisor and a worker who uses a space, and titles such as a representative director, a director, an executive officer, a department manager, a section manager, a team leader, and a staff member may be used.

Alternatively, stakeholders such as investors, sales staffs, and customers may be used or industries such as construction, logistics, real estate, entertainment, retail, transportation, information communication, commerce, finance, services, fisheries, agriculture, forestry, mining, electricity, and gas may be used.

### 4. Medium

This item is for information on a medium to be used for recommendation. Although information is typically provided as a recommendation in text, other media may be used for providing a recommendation. For example, when the user is focusing on a particular object, a check report (portable document format (PDF)) or a document file related to the object is provided as a recommendation.

The text also can be read out as speech or pre-recorded speech can be played back. Further, assuming a scene in which a 3D model is desired to be arranged in using the space, multiple candidates for the 3D model can be presented, and a 3D model that is picked up and arranged in the space can be used as a medium to be used for providing a recommendation.

### 5. Operation

This item is for a trigger for determining a medium used for recommendation. In other words, the item corresponds to a user operation, and a medium is determined by inputting the information.

For example, when a space is operated with a personal computer (PC), the input operations include a viewing operation such as clicking with an input device such as a mouse or keyboard, mouse movement, gazing (for example, the center of the screen is defined as a user's stop area), and enlargement/reduction, and an input operation such as text input, voice input via a microphone, and file attachment.

In other words, in the case of providing information as a recommendation in response to an operation of clicking on any desired object, when the mouse is moved frequently, the situation is considered that the user is unsure about something, and information related to the situation is provided as a recommendation. Further, an immersive operation into a 3D space that is represented by a metaverse, is also considered. In other words, actions corresponding to the behavior of the user in the real space corresponding to the behavior of an avatar of the user in 3D can be used as a trigger. The actions include seeing an object in the 3D space (gaze information) and touching an object in the 3D space (touch). In particular, operations specific to a 3D are described in the following description of the present embodiment.

### 6. Interface

Examples of interface include a non-immersive device such as a PC, a smartphone, or a tablet, and an immersive device such as a virtual reality (VR) goggle or argument reality (AR) glasses.

As described above, by defining each item and item content in the various conditions in detail, useful information with little noise can be provided as a recommendation.

A method of switching between the ON and OFF of the recommendation function can be performed with the system. For example, a method of switching the recommendation function to ON when the check box of “recommendation function” indicates being selected can be used.

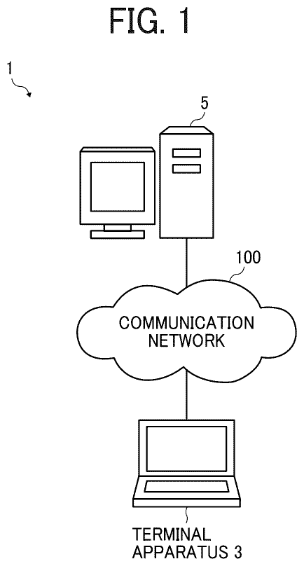

FIG. 1 is a diagram illustrating an overall configuration of a three-dimensional shape generation system according to an embodiment. A point cloud processing system 1 according to the present embodiment includes a terminal apparatus 3 that is an example of an input and output apparatus, and a server 5.

The server 5 is an example of an information processing apparatus connected to an input and output apparatus via a network. The server 5 is an example of a three-dimensional shape generation apparatus that generates three-dimensional shape information representing a three-dimensional shape corresponding to a three-dimensional point cloud using model shape information representing a three-dimensional model shape.

In the description of the present embodiment, the three-dimensional point cloud is a collection of coordinate points in a virtual three-dimensional space that can be processed by a computer. The three-dimensional point cloud may also be referred to as a point cloud. The three-dimensional point cloud is defined as a collection of coordinate points corresponding to measurement points on the surfaces of an object when a certain space in which the object is present is measured using, for example, a laser scanner LS. Further, color information may be added to each of the coordinate points, and, as the color information, an RGB value may be added to each of the coordinate points.

In the present embodiment, the three-dimensional point cloud is measured using the laser scanner LS. Another optical measurement means or a mechanical measurement means may be used. As the optical measuring means, for example, a method using a stereo camera or a method using Visual Simultaneous Localization and Mapping (SLAM) is used.

The three-dimensional shape information is information representing a three-dimensional shape of an object that can be processed by, for example, a computer. The information representing a three-dimensional shape is information that can geometrically specify a three-dimensional shape, and for example, in the case of a sphere, the coordinates of the center and the radius correspond to the information representing the three-dimensional shape. When the three-dimensional shape of an object is represented by a polyhedron (polygon), the coordinate points of the vertices of the polyhedron are an example of information representing the three-dimensional shape. In addition, as information that occupies a three-dimensional shape, any information can be used as long as the information can uniquely define the shape of the object.

The three-dimensional shape information may include information on the color and material of the object in addition to the information representing the three-dimensional shape of the object.

The three-dimensional model shape is a model such as a prototype or a template used for generating three-dimensional shape information from a three-dimensional point cloud. The model shape information is information indicating a three-dimensional model shape, and one piece of model shape information corresponds to one three-dimensional model shape.

The model shape information may include information related to the color or the material of the three-dimensional model in addition to the three-dimensional model shape. Specifically, the three-dimensional model shape representing a plane may include information called texture such as the color or the pattern of a wall and information on the material.

The information on texture can implement CAD model representation with colors and patterns easily. Further, the information on material can be directly transferred to a CAD model that can include the information on material. This can eliminate the time and effort of the user to configure settings.

In the description of the present embodiment, the “texture” originally indicates the surface quality or tactile feel of an object, and in the three-dimensional shape information, indicates a pattern or an image to be attached to the surface of the three-dimensional shape in order to express the texture of the surface of the object.

Further, the CAD model typically includes a method of creating “surface”, “solid”, and “polygon”. The “solid” has detailed information on material as well as an appearance, and with the “solid”, mass and volume can be calculated and a cross-sectional shape can be represented. Accordingly, the “solid” allows for the closest representation of an actual object.

Further, setting, for example, a color, a material, brightness, and a background to a CAD model is referred to as “rendering”, and a clear image like a photograph can be created by rendering.

As described above, the three-dimensional shape information includes a three-dimensional geometric shape processed by 3D CAD, BIM, or CIM, geometric information, mesh objects, and textured polygon information.

The terminal apparatus 3 and the server 5 can communicate with each other via a communication network 100. The communication network 100 is implemented by, for example, the Internet, a mobile communication network, or a local area network (LAN). The communication network 100 may include, in addition to wired communication networks, wireless communication networks in compliance with, for example, 3rd generation (3G), Worldwide Interoperability for Microwave Access (WiMAX), or long term evolution (LTE). Further, the terminal apparatus 3 can establish communication using a short-range communication technology such as NEAR FIELD COMMUNICATION (NFC) (registered trademark).

### Hardware Configuration

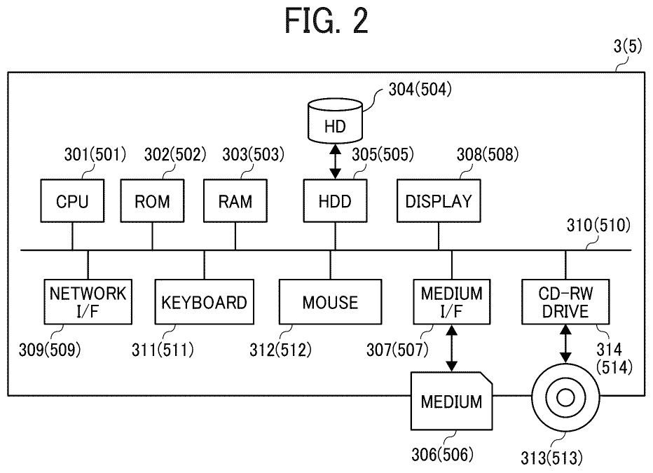

FIG. 2 is a block diagram illustrating a hardware configuration of each of the terminal apparatus and the server according to the present embodiment. The hardware components of the terminal apparatus 3 are denoted by reference numerals in the 300 series. The hardware components of the server 5 are denoted by reference numerals in the 500 series with brackets.

The terminal apparatus 3 includes a central processing unit (CPU) 301, a read-only memory (ROM) 302, a random-access memory (RAM) 303, a hard disk (HD) 304, a hard disk drive (HDD) 305, a medium interface (I/F) 307 that controls the reading and writing of various data from and to a recording medium 306, a display 308, a network I/F 309, a keyboard 311, a mouse 312, a compact disc-rewritable (CD-RW) drive 314, and a bus line 310.

The CPU 301 performs the overall control of the operation of the terminal apparatus 3. The ROM 302 stores a program for driving the CPU 301. The RAM 303 is used as a working area for the CPU 301. The HD 304 stores various data such as a program. The HDD 305 controls the reading and writing of various data to and from the HD 304 under the control of the CPU 301. The medium I/F 307 controls the reading and writing of various data from and to the recording medium 306. The display 308 displays various information such as a cursor, a menu, a window, a character, or an image. The network I/F 309 is an interface for transmitting and receiving data (performing communications) via the communication network 100. The keyboard 311 is an input device that is provided with multiple keys that allow a user to input, for example, characters, numerals, or various instructions. The mouse 312 is another input device that allows a user to perform an operation for, for example, selecting or executing various instructions, selecting objects to be processed, or moving a cursor being displayed. The CD-RW drive 314 controls the reading and writing of various data from and to the CD-RW 313 that is an example of a removable recording medium.

The server 5 includes a CPU 501, a ROM 502, a RAM 503, an HD 504, an HDD 505, a medium I/F 507 that controls the reading and writing of various data from and to a recording medium 506, a display 508, a network I/F 509, a keyboard 511, a mouse 512, a CD-RW drive 514, and a bus line 510. The above-described components of the server 5 are substantially the same as or similar to the above-described components (the CPU 301, the ROM 302, the RAM 303, the HD 304, the HDD 305, the recording medium 306, the medium I/F 307, the display 308, the network I/F 309, the keyboard 311, the mouse 312, the CD-RW drive 314, and the bus line 310) of the terminal device 3. Thus, the redundant description is omitted.

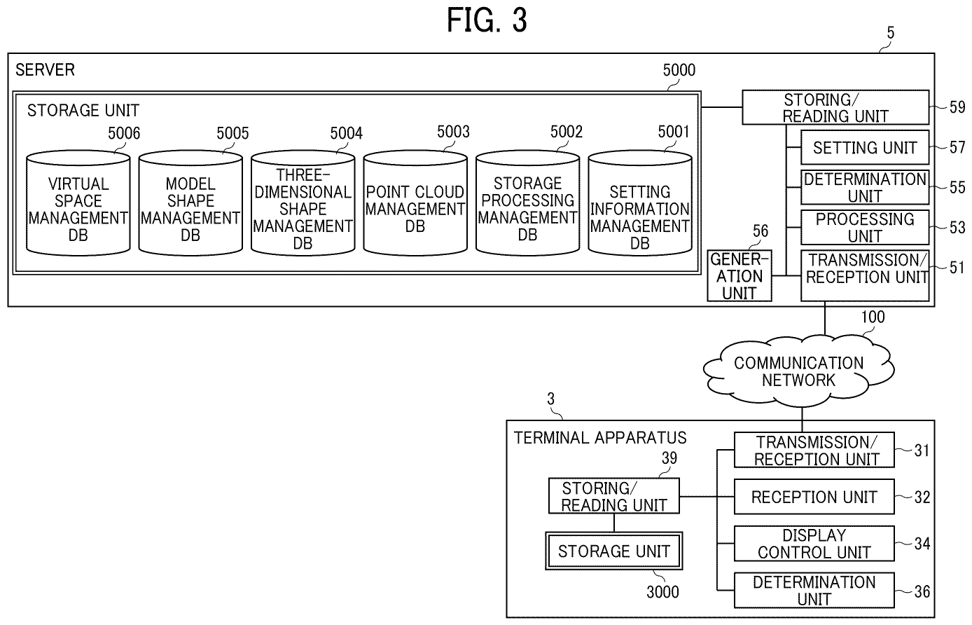

A compact disc-recordable (CD-R) drive may be used as an alternative to the CD-RW drive 314 (514). Each of the terminal apparatus 3 and the server 5 may be implemented by a single computer or multiple computers to which divided units (functions, means, or storage units) are allocated as desired. FIG. 3 is a block diagram illustrating a functional configuration of the three-dimensional shape generation system according to the present embodiment.

As illustrated in FIG. 3, the terminal apparatus 3 includes a transmission/reception unit 31, a reception unit 32, a display control unit 34, a determination unit 36, and a storing/reading unit 39. Each of the above-mentioned units is a function that is implemented by or that is caused to function by operating one or more of the components illustrated in FIG. 2 according to an instruction from the CPU 301 operating according to a program loaded from the HD 304 to the RAM 303. The terminal apparatus 3 further includes a storage unit 3000 implemented by the RAM 303 and the HD 304 illustrated in FIG. 2.

### Functional Units of Terminal Apparatus

Each functional unit of the terminal apparatus 3 is described below.

The transmission/reception unit 31 is an example of a transmission unit and is implemented by an instruction from the CPU 301 illustrated in FIG. 2 and the network I/F 309 illustrated in FIG. 2. The transmission/reception unit 31 transmits and receives various data (or information) to and from another terminal, device, apparatus, or system via the communication network 100.

The reception unit 32 is an example of a reception unit and is implemented by an instruction from the CPU 301 illustrated in FIG. 2 and the keyboard 311 or the mouse 312 illustrated in FIG. 2. The reception unit 32 receives various inputs from a user.

The display control unit 34 is an example of a display control unit and is implemented by an instruction from the CPU 301 illustrated in FIG. 2. The display control unit 34 causes the display 308 that is an example of a display unit to display various images and screens.

The determination unit 36 is an example of a determination unit and is implemented by an instruction from the CPU 301 illustrated in FIG. 2, and performs various determinations.

The storing/reading unit 39 is an example of a storage control unit and implemented by an instruction from the CPU 301 illustrated in FIG. 2 and the HDD 305, the medium I/F 307, and the CD-RW drive 314 illustrated in FIG. 2. The storing/reading unit 39 stores various data in the storage unit 3000, the recording medium 306, or the CD-RW 313 and reads various data from the storage unit 3000, the recording medium 306, or the CD-RW 313.

### Functional Configuration of Server

The server 5 includes transmission/reception unit 51, a processing unit 53, a determination unit 55, a generation unit 56, a setting unit 57, and a storing/reading unit 59. Each of the above-mentioned units is a function that is implemented by or that is caused to function by operating one or more of the components illustrated in FIG. 2 according to an instruction from the CPU 501 operating according to a program loaded from the HD 504 to the RAM 503. The server 5 further includes a storage unit 5000 implemented by the HD 504 illustrated in FIG. 2. The storage unit 5000 is an example of a storage unit.

### Functional Units of Server

Each functional unit of the server 5 is described below. The server 5 may be implemented by multiple computers in a manner that some or all of the functions are distributed to the multiple computers. Although the server 5 is a server computer that resides in a cloud environment in the following description of the present embodiment, alternatively, the management server 5 may be a server that resides in an on-premises environment.

The transmission/reception unit 51 is an example of a transmission unit and is implemented by an instruction from the CPU 501 illustrated in FIG. 2 and the network I/F 509 illustrated in FIG. 2. The transmission/reception unit 51 transmits and receives various data (or information) to and from another terminal, device, apparatus, or system via the communication network 100.

The processing unit 53 is an example of a processing unit and is implemented by an instruction from the CPU 501 illustrated in FIG. 2. The processing unit 53 performs various processing described later. The processing unit 53 is an example of a three-dimensional information generation unit that generates three-dimensional shape information.

The determination unit 55 is an example of a determination unit and is implemented by an instruction from the CPU 501 illustrated in FIG. 2. The determination unit 55 performs various determinations described later.

The generation unit 56 is an example of a generation unit and is implemented by an instruction from the CPU 501 illustrated in FIG. 2. The generation unit 56 generates various screens.

The setting unit 57 is an example of a setting unit and is implemented by an instruction from the CPU 501 illustrated in FIG. 2. The setting unit 57 performs various settings and determinations described later.

The storing/reading unit 59 is an example of a storage control unit and implemented by an instruction from the CPU 501 illustrated in FIG. 2 and the HDD 505, the medium I/F 507, and the CD-RW drive 514 illustrated in FIG. 2. The storing/reading unit 59 stores various data in the storage unit 5000, the recording medium 506, or the CD-RW 513 and reads various data from the storage unit 5000, the recording medium 506, or the CD-RW 513. Each of the storage unit 5000, the recording medium 506, and the CD-RW 513 is an example of a storage unit.

The storage unit 5000 includes a setting information management database (DB) 5001 including a setting information management table, a storage processing management DB 5002, a point cloud management DB 5003, a three-dimensional shape management DB 5004, a model shape management DB 5005, and a virtual space management DB 5006 including a virtual space management table.

In the setting information management DB 5001, various information is stored and managed. In the storage processing management DB 5002, various processing programs for generating point cloud shapes are stored and managed. In the point cloud management DB 5003, three-dimensional point cloud information for generating point cloud shapes is stored and managed. In the three-dimensional shape management DB 5004, three-dimensional shape information generated using model shape information is stored and managed. In the model shape management DB 5005, model shape information indicating a three-dimensional model shape is stored and managed for each model identifier (model identification information). In the virtual space management DB 5006 information on a virtual space including a three-dimensional shape is stored and managed.

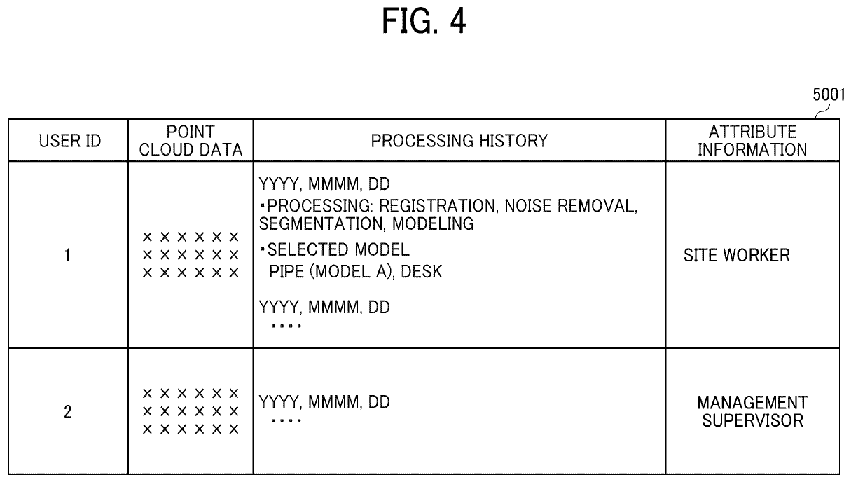

FIG. 4 is a conceptual diagram illustrating a setting information management table according to the present embodiment.

The setting information management table is a table for managing three-dimensional point cloud data for generating a three-dimensional shape and processing the history of generating a three-dimensional shape. In the storage unit 5000, the setting information management DB 5001 including the setting information management table as illustrated in FIG. 4 is implemented. In the setting information management table, a file name of three-dimensional point cloud data, processing history of generating a three-dimensional shape, and attribute information indicating a user attribute are associated with each other and managed for each user ID.

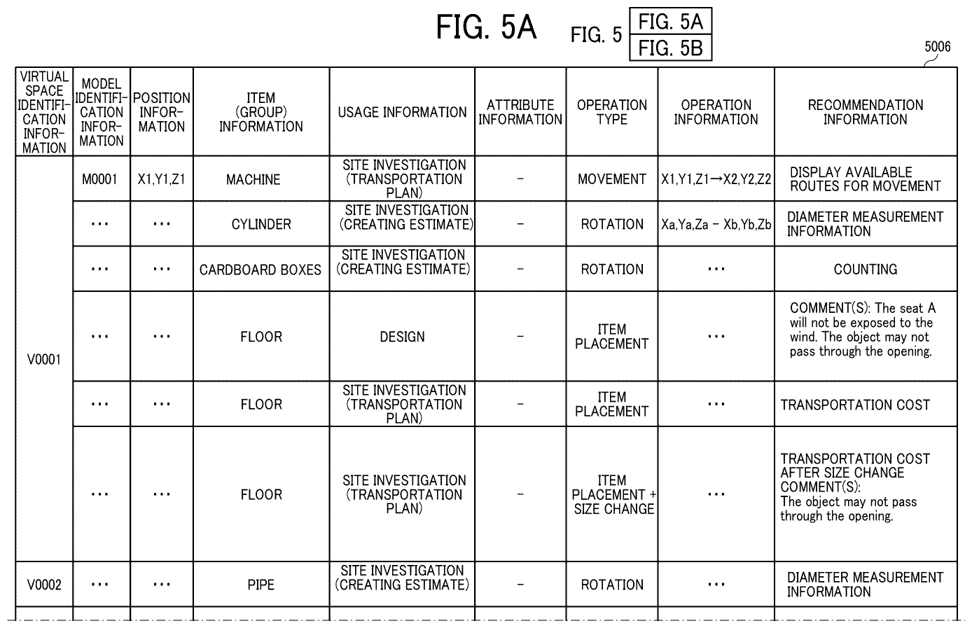

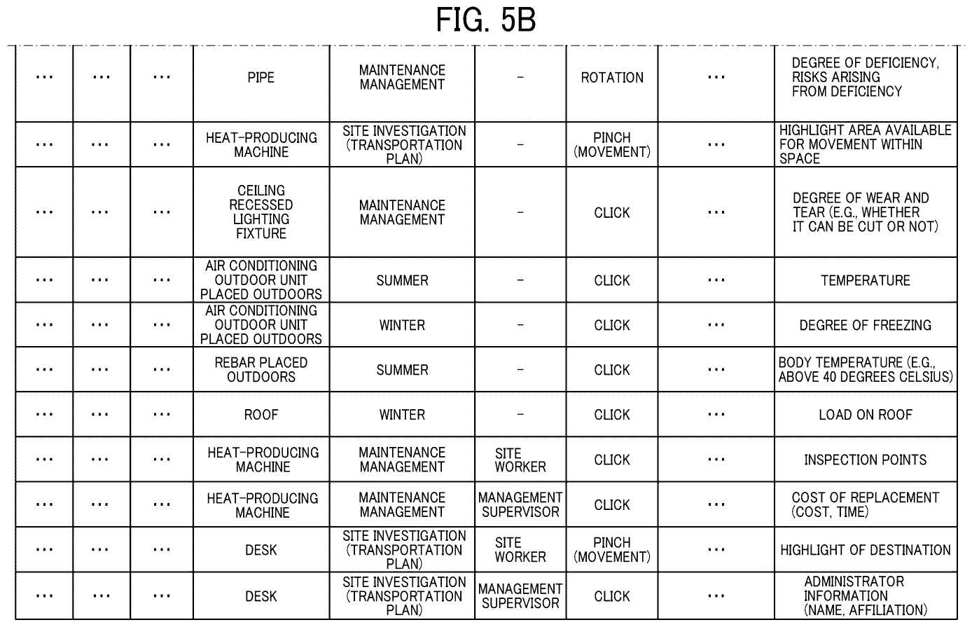

FIGS. 5A and 5B are conceptual diagrams illustrating a virtual space management table according to the present embodiment.

The virtual space management table is a table for managing information on a virtual space including three-dimensional shape information. In the storage unit 5000, the virtual space management DB 5006 including the virtual space management table as illustrated in FIGS. 5A and 5B is implemented.

In the virtual space management table, model identification information, position information, item information, usage information, attribute information, operation name, operation information, and recommendation information are managed in association with each other for each virtual space identifier (virtual space identification information) for identifying a virtual space.

The model identification information is information for identifying model shape information representing a three-dimensional model shape, and the position information is information indicating the position of the three-dimensional model shape in the virtual space by three-dimensional coordinates of XYZ.

The item information is information on an item indicated by a specific three-dimensional shape including one or more model shapes.

The usage information is information for identifying a usage scenario in which the three-dimensional shape displayed on the display 308 is used, and includes a time of year to use the three-dimensional shape and a task using the three-dimensional shape.

The attribute information is information for identifying an attribute of the user who operates the three-dimensional shape displayed on the display 308.

The operation type indicates the type of operation performed on a specific three-dimensional shape. The operation information is information representing an operation on a specific three-dimensional shape as an operation identified by three-dimensional coordinates of XYZ. For example, a movement operation is specified by an operation of linearly moving from a start point indicated by a three-dimensional coordinate (X1, Y1, Z1) to an end point indicated by a three-dimensional coordinate (X2, Y2, Z2). For example, a rotation operation is specified by an operation of moving on a circumference from a starting point indicated by a three-dimensional coordinate (Xa, Ya, Za) to an ending point indicated by a three-dimensional coordinate (Xb, Yb, Zb).

The recommendation information is an example of specific information corresponding to a specific three-dimensional shape and a specific operation, and indicates information that may be useful for a user who performs the specific operation on the specific three-dimensional shape.

The recommendation information may include multiple selectable information items corresponding to a specific three-dimensional shape and a specific operation. Further, the multiple selectable information items to be presented may be determined based on a predefined priority.

Further, the recommendation information may be specific information corresponding to multiple specific three-dimensional shapes and a specific operation on the multiple specific three-dimensional shapes, or may be specific information corresponding to a specific three-dimensional shape and multiple specific operations for the specific three-dimensional shape.

In a case where the recommendation information is specific information corresponding to multiple specific three-dimensional shapes and a specific operation on the multiple specific three-dimensional shapes, the operation information includes the temporal aspect of the operation, and the recommendation information is specified by reflecting the temporal aspect of the operation.

For example, there is a case of performing measurement, a pipe A is clicked and measured, and then a machine body B connected to the pipe A is clicked and measured.

In this case, when the user clicks the machine body B after clicking the pipe A and further performing an any desired operation such as an operation for measurement, a recommendation such as “Check the pipe F because it also has a similar shape” is made.

This can be achieved by recording operations for a predetermined period of time as operation information, and determining, when a certain operation is performed, whether an operation having a temporal aspect related to the temporal aspect of the certain operation is present within the predetermined period of time. In particular, in the case of, for example, maintenance management or safety confirmation, the check targets and the checking order are often determined, and performing the maintenance management or the safety confirmation by referring to the manual at hand is inefficient. To cope with this, by using such a temporal aspect of operation, information indicating a task to be performed next can be provided as a recommendation.

The recommendation information determined by data analysis may be used in addition to or in an alternative to the one predefined. For example, there is a conceivable method in which specific information is extracted from a raw text (memo) given by a user to a certain point or a certain object in a space by a text mining method such as clustering, and the extracted information is associated with (added to) the point or the object.

Further, there is another conceivable method in which a document file attached to a certain point in a space is analyzed by an information processing technique such as OCR and extracted text is used. For example, in a case where a report (malfunction repair report) in which malfunction information is collected is issued for a certain machine, a cause of malfunction, a location of malfunction, a solution, or a solution procedure, is extracted based on information extracted from the report based on the report. Then, it is considered that similar machines are searched for using a three-dimensional (3D) object detection (object search) technique and the information extracted from the report is associated with the machines. As described above, in addition to the method of associating information in advance as an intention, a method of using information extracted from a recorded work log in utilizing a space as recommendation information is also conceivable.

### Management of Different Information for Same Three-dimensional Shape for Each Different Operation

The virtual space management table described above stores, for the same three-dimensional shape (first three-dimensional shape), an operation (first operation) and information (first information) in association with each other, and also an additional operation (second operation) and additional information (second information) in association with each other.

Specifically, for a three-dimensional shape whose item information is a floor, an operation for item placement (first operation) and recommendation information including a comment of “The seat A will not be exposed to the wind.” and a comment of “The object may not pass through the opening.” (first information) are stored in association with each other, and an operation for item placement and size change (second operation) and recommendation information including “TRANSPORTATION COST AFTER SIZE CHANGE” and a comment of “The object may not pass through the opening.” (second information) are stored in association with each other.

### Management of Different Information for Same Operation for Each Different Three-Dimensional Shape

Further, the virtual space management table stores an operation (first operation) on a three-dimensional shape (first three-dimensional shape) and information (first information) in association with each other, and also stores the operation (first operation) on an additional three-dimensional shape (second three-dimensional shape) and additional information (second information) in association with each other. In other words, the virtual space management table stores, for the same operation (first operation), the first three-dimensional shape and the first information in association with each other, and the second three-dimensional shape and the second information in association with each other.

Specifically, the virtual space management table stores an operation for rotation (first operation) of a three-dimensional shape corresponding to item information indicating a cylinder (first three-dimensional shape) in association with recommendation information (first information) related to “DIAMETER MEASUREMENT INFORMATION”, and also stores the operation for rotation (first operation) of a three-dimensional shape corresponding to item information indicating multiple cardboard boxes (second three-dimensional shape) in association with recommendation information related to “COUNTING” (second information).

### Management of Different Information for Each Combination of Three-Dimensional Shape and Operation

Further, the virtual space management table stores an operation (first operation) on a three-dimensional shape (first three-dimensional shape) in association with information (first information), and also stores an additional operation (second operation) on an additional three-dimensional shape (second three-dimensional shape) in association with additional information (second information).

Specifically, the virtual space management table stores an operation for movement (first operation) of a three-dimensional shape corresponding to item information indicating a machine (first three-dimensional shape) in association with recommendation information related to “AVAILABLE ROUTE FOR MOVEMENT” (first information), and also stores the operation for rotation (second operation) of the three-dimensional shape corresponding to item information indicating multiple cardboard boxes (second three-dimensional shape) in association with the recommendation information related to “COUNTING” (second information).

### Management of Different Information for Each Condition for Same Three-dimensional Shape and Same Operation

Further, the virtual space management table stores, for a three-dimensional shape (first three-dimensional shape) and an operation (first operation), information (first information) corresponding to a condition (first condition) in association with each other, and also additional information (second information) corresponding to an additional condition (second condition) in association with each other.

### Management of Different Information for Each Condition Related to Task Using Three-Dimensional Shape

Specifically, the virtual space management table stores, for item information indicating a three-dimensional shape of a floor (first three-dimensional shape) and an operation for item placement (first operation), usage information indicating “DESIGN” as a task (first condition) and recommendation information related to a comment of “The seat A will not be exposed to the wind.” (first information) in association with each other, and usage information indicating “SITE INVESTIGATION (TRANSPORTATION PLAN)” as a task (second condition) and recommendation information related to “TRANSPORTATION COST” (second information) in association with each other.

Similarly, the virtual space management table stores, for item information indicating a three-dimensional shape of a pipe (first three-dimensional shape) and the operation for rotation (first operation), usage information indicating “SITE INVESTIGATION (CREATING ESTIMATE)” as a task (first condition) and recommendation information related to “DIAMETER MEASUREMENT INFORMATION” (first information) in association with each other, and usage information indicating “MAINTENANCE” as a task (second condition) and recommendation information related to “DEGREE OF DEFICIENCY, RISKS ARISING FROM DEFICIENCY” (second information) in association with each other.

### Management of Different Information for Each Condition Related to Time of Year to Use Three-Dimensional Shape

Further, the virtual space management table stores, for item information indicating a three-dimensional shape of an air conditioning outdoor unit placed outdoors (first three-dimensional shape) and an operation of clicking (first operation), usage information indicating “SUMMER” as a time of year (first condition) and recommendation information related to “TEMPERATURE” (first information) in association each other, and usage information indicating “WINTER” as a time of year (second condition) and recommendation information related to “DEGREE OF FREEZING” (second information) in association with each other.

Management of Different Information for Each Condition related to User Attribute Further, the virtual space management table stores, for item information indicating a three-dimensional shape of a heat-producing machine (first three-dimensional shape) and the operation of clicking (first operation), attribute information indicating “SITE WORKER” (first condition) and recommendation information related to “INSPECTION POINTS” (first information) in association with each other, and also attribute information indicating “MANAGEMENT SUPERVISOR” (second condition) and recommendation information related to “COST OF REPLACEMENT (COST, TIME)” (second information) in association with each other.

### Management of Information on Specific Condition for Same Three-dimensional Shape and Same Operation

In the description of the present embodiment, the virtual space management table stores, for a three-dimensional shape (first three-dimensional shape) and an operation (first operation), information (first information) corresponding to a condition (first condition) in association with each other, but may not store, for the three-dimensional shape (first three-dimensional shape) and the operation (first operation), additional information (second information) corresponding to an additional condition (second condition) in association with each other.

Management of Information on Specific Condition on Task Using Three-Dimensional Shape Specifically, the virtual space management table stores, for item information indicating a three-dimensional shape of a heat-producing machine and an operation for pinch (movement), usage information indicating “SITE INVESTIGATION (TRANSPORTATION PLAN)” as a task and recommendation information related to “HIGHLIGHT AREA AVAILABLE FOR MOVEMENT WITHIN SPACE” in association with each other, but does not store recommendation information in a case of usage information indicating “MAINTENANCE MANAGEMENT” as a task because “MAINTENANCE MANAGEMENT” does not replace items and does not require moving items.

Similarly, the virtual space management table stores no recommendation information for item information indicating a three-dimensional shape of ceiling recessed lighting fixture and an operation of clicking in the case that the associated usage information indicates “SITE INVESTIGATION (TRANSPORTATION PLAN)” as a task, because the recessed ceiling lighting fixture hardly be an obstacle or moved.

### Management of Information on Specific Condition on Time of Year to Use Three-Dimensional Shape

Further, the virtual space management table stores, for item information indicating a three-dimensional shape of rebar placed outdoors and an operation of clicking, usage information indicating “SUMMER” as a time of year and recommendation information related to “BODY TEMPERATURE” in association each other. However, for the item information indicating a three-dimensional shape of rebar placed outdoors and the operation of clicking that are associated with usage information indicating “WINTER” as a time of year, no recommendation information is stored, because there is little risk of burns even at high temperatures.

Similarly, in the virtual space management table, for item information indicating a three-dimensional shape of a roof and an operation of clicking that are associated with usage information indicating “SUMMER” as a time of year, no recommendation information is stored, because there is no possibility that a roof collapses due to snow cover.

Management of Information on Specific Condition related to User Attribute Further, the virtual space management table stores, for item information indicating a three-dimensional shape of a desk and an operation for pinch (movement), attribute information indicating “SITE WORKER” and recommendation information related to “HIGHLIGHT DESTINATION” in association with each other. However, for the item information indicating a three-dimensional shape of desk and the operation for pinch (movement) that are associated with attribute information indicating “MANAGEMENT SUPERVISOR”, no recommendation information is stored, because item placement can be controlled by the management supervisor.

Similarly, in the virtual space management table, for item information indicating a three-dimensional shape of a desk and an operation of clicking that are associated with attribute information indicating “SITE WORKER”, no recommendation information is stored because the worker does not need to know who manages the desk.

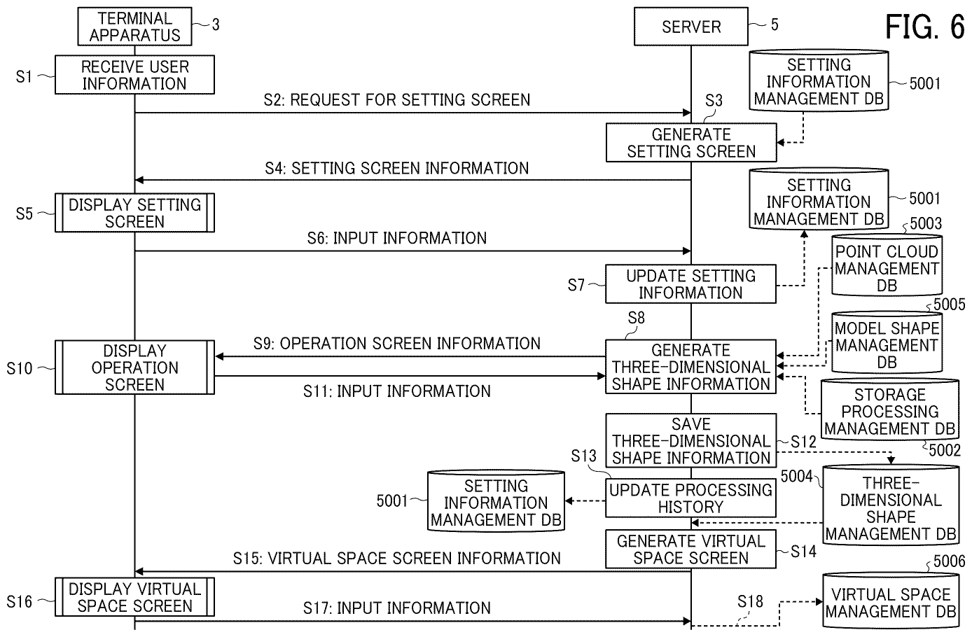

FIG. 6 is a sequence diagram illustrating a three-dimensional shape generation process according to the present embodiment.

The reception unit 32 of the terminal apparatus 3 receives an input operation related to user information of the user on an input and output screen displayed on the display 308 (Step S1). The transmission/reception unit 31 transmits, to the server 5, a request for a setting screen including the user information received in Step S1, and the transmission/reception unit 51 of the server 5 receives the request transmitted from the terminal apparatus 3 (Step S2).

Subsequently, the storing/reading unit 59 of the server 5 searches the setting information management DB 5001 using the user information included in the request received in Step S2 as a search key to read a file name of three-dimensional point cloud data and processing history of generating a three-dimensional shape that are associated with the user information included in the request, and the generation unit 56 of the management server 5 generates a setting screen based on the file name read by the storing/reading unit 59 (Step S3).

The setting screen includes a model information setting screen for receiving a model setting operation for setting multiple pieces of model shape information to be used for generating three-dimensional shape information from the multiple pieces of model shape information, a point cloud setting screen for receiving a point cloud setting operation for setting a three-dimensional point cloud to be used for generating the three-dimensional shape information, and a processing setting screen for receiving a processing setting operation for setting a processing program for generating the three-dimensional shape information.

The processing setting screen includes a display component for which the initial settings have been applied based on the history read by the storing/reading unit 59.

The transmission/reception unit 51 transmits to the terminal apparatus 3 setting screen information related to the setting screen generated in Step S3, and the transmission/reception unit 31 of the terminal apparatus 3 receives the setting screen information transmitted from the server 5 (Step S4). Step S4 is an example of a transmission step of transmitting model information setting screen information related to a model information setting screen, and the transmission/reception unit 31 is an example of a transmission unit.

Subsequently, the display control unit 34 of the terminal apparatus 3 causes the display 308 to display the setting screen received in Step S4 (Step S5). The reception unit 32 of the terminal apparatus 3 receives an input operation performed by the user on the displayed setting screen. The input operation includes a model setting operation for setting multiple pieces of model shape information to be used for generating three-dimensional shape information from the multiple pieces of model shape information, a point cloud setting operation, and a processing setting operation. Step S5 is an example of a reception step of receiving a model setting operation for setting multiple pieces of model shape information to be used for generating three-dimensional shape information from the multiple pieces of model shape information.

The transmission/reception unit 31 transmits, to the server 5, input information related to the input operation received by the reception unit 32, and the transmission/reception unit 51 of the server 5 receives the input information transmitted from the terminal apparatus 3 (Step S6). The input information includes model setting information for setting the multiple pieces of model shape information to be used for generating three-dimensional shape information, point cloud setting information, and processing setting information.

The storing/reading unit 59 of the server 5 updates the processing history of generating a three-dimensional shape stored in the setting information management DB 5001 in association with the user information, based on the processing setting information and the model setting information included in the input information received in Step S6 (Step S7).

Subsequently, the storing/reading unit 59 of the server 5 searches the point cloud management DB 5003 using the point cloud setting information included in the input information received in Step S6 as a search key to read three-dimensional point cloud data associated with the point cloud setting information.

Further, the storing/reading unit 59 searches the storage processing management DB 5002 using the processing setting information included in the input information received in Step S6 as a search key to read a processing program associated with the processing setting information.

Then, the storing/reading unit 59 searches the model shape management DB 5005 using model identification information corresponding to the model setting information included in the input information received in Step S6 as a search key, and reads a three-dimensional model shape associated with the model identification information.

The processing unit 53 of the server 5 generates three-dimensional shape information based on the three-dimensional point cloud data, the processing program, and the three-dimensional model shape read by the storing/reading unit 59 (Step S8).

Step S8 is an example of a three-dimensional information generation step of generating three-dimensional shape information using multiple pieces of model shape information set by a model setting operation based on the model setting operation on a model information setting screen 1230 and point cloud information representing a three-dimensional point cloud.

The generation unit 56 of the server 5 generates an operation screen for receiving operations or inputs for generating three-dimensional shape information, and the transmission/reception unit 51 transmits to the terminal apparatus 3 operation screen information related to the operation screen (Step S9).

The transmission/reception unit 31 of the terminal apparatus 3 receives the operation screen information transmitted from the server 5, the display control unit 34 of the terminal apparatus 3 displays the received operation screen on the display 308, and the reception unit 32 of the terminal apparatus 3 receives a predetermined input operation performed by the user on the displayed operation screen (Step S10).

The input operation includes a shape setting operation for setting (selecting) one piece of three-dimensional shape information from among the multiple pieces of three-dimensional shape information.

The transmission/reception unit 31 transmits, to the server 5, input information related to the input operation received by the reception unit 32, and the transmission/reception unit 51 of the server 5 receives the input information transmitted from the terminal apparatus 3 (Step S11).

The input information includes shape setting information corresponding to the shape setting operation, and the processing unit 53 of the server 5 determines three-dimensional shape information based on the shape setting information included in the input information received in Step S11.

The terminal apparatus 3 and the server 5 repeatedly execute steps S8 to S11 as appropriate.

The processing unit 53 converts the generated three-dimensional shape information into, for example, a CAD format, and the storing/reading unit 59 stores the converted three-dimensional shape information in the three-dimensional shape management DB 5004, the recording medium 506, or the CD-RW 513 in association with model identification information for identifying each of one or more model shapes used to generate three-dimensional shapes and position information in the three-dimensional point cloud data read in step S8 (Step S12). The CAD format is three-dimensional shape information that can be processed in a 3D CAD. In a case of using commercial 3D CAD for three-dimensional shape information, the three-dimensional shape information is converted into a 3D CAD format.

The storing/reading unit 59 updates the processing history of generating a three-dimensional shape stored in the setting information management DB 5001 in association with the user information based on model shape information corresponding to the determined three-dimensional shape information (Step S13).

Subsequently, the storing/reading unit 59 of the server 5 reads from the three-dimensional shape management DB 5004 the three-dimensional shape information generated based on the three-dimensional point cloud data read in Step S8, along with the model identification information and the position information, and the generation unit 56 of the server 5 generates a virtual space screen including the three-dimensional shape read by the storing/reading unit 59 (Step S14). The virtual space screen is a screen displaying a space related to the three-dimensional point cloud data read in Step S8 as a virtual space including one or more three-dimensional shapes generated based on the three-dimensional point cloud data.

The transmission/reception unit 51 transmits to the terminal apparatus 3 virtual space screen information indicating the virtual space screen generated in Step S14 (Step S15).

The transmission/reception unit 31 of the terminal apparatus 3 receives the virtual space screen information transmitted from the server 5, and the display control unit 34 of the terminal apparatus 3 causes the display 308 to display the virtual space screen represented by the received virtual space screen information (Step S16).

The reception unit 32 of the terminal apparatus 3 receives a predetermined input operation performed on the displayed virtual space screen by the user. The input operation includes an operation of setting for the virtual space identification information, the item information, usage information, the attribute information, the operation type, the operation information, and the recommendation information illustrated in FIGS. 5A and 5B.

The transmission/reception unit 31 transmits, to the server 5, input information related to the input operation received by the reception unit 32, and the transmission/reception unit 51 of the server 5 receives the input information transmitted from the terminal apparatus 3 (Step S17). The input information includes the virtual space identification information, the item information, usage information, the attribute information, the operation type, the operation information, and the recommendation information.

The storing/reading unit 59 of the server 5 stores in the virtual space management DB the virtual space identification information, the item information, the usage information, the attribute information, the operation type, the operation information, and the recommendation information included in the input information received in Step S17 in association with the model identification information and the position information read in Step S14 (Step S18). As a result, various information illustrated in FIGS. 5A and 5B is stored in the virtual space management DB 5006.

The functional units of the server 5 in FIG. 3 may be integrated into the terminal apparatus 3, and the processing of the server 5 described with reference to FIG. 6 is executed by the terminal apparatus 3.

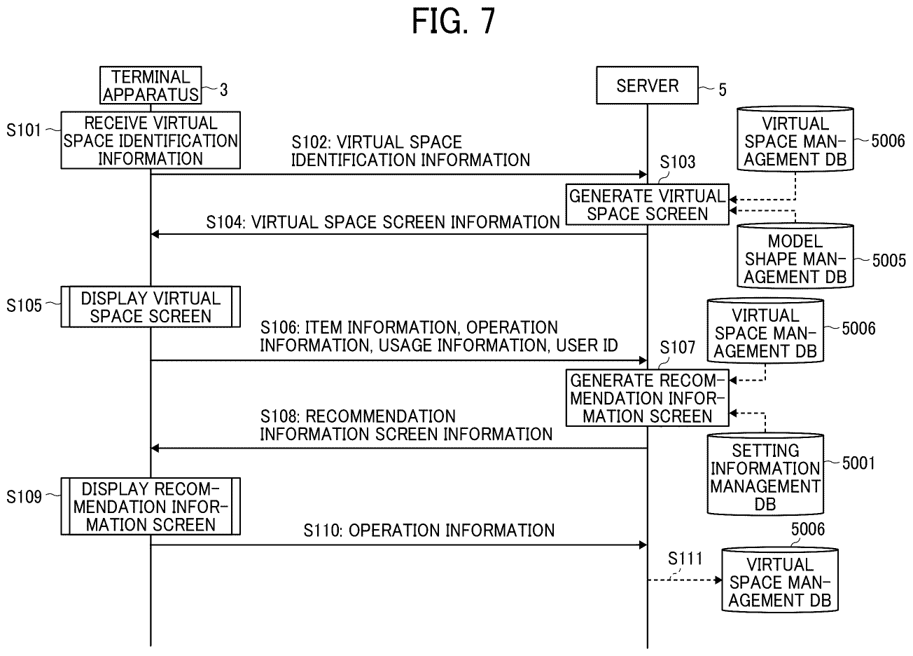

FIG. 7 is a sequence diagram illustrating a virtual space operation process according to the present embodiment.

The reception unit 32 of the terminal apparatus 3 receives an input operation related to virtual space identification information and performed on an input and output screen displayed on the display 308 (Step S101).

The transmission/reception unit 31 transmits, to the server 5, the virtual space identification information related to input operation received by the reception unit 32 in Step S101, and the transmission/reception unit 51 of the server 5 receives the virtual space identification information transmitted from the terminal apparatus 3 (Step S102).

The storing/reading unit 59 of the server 5 reads model identification information, position information, and item information associated with the virtual space identification information by searching the virtual space management DB 5006 using the virtual space identification information received in Step S102 as a search key, and reads a three-dimensional model shape associated with the model identification information by searching the model shape management DB 5005 using the model identification information read from the virtual space management DB 5006 as a search key.

The generation unit 56 of the server 5 generates a virtual space screen based on the model identification information, the three-dimensional model shape, the position information, and the item information read by the storing/reading unit 59 (Step S103).

The transmission/reception unit 51 transmits to the terminal apparatus 3 virtual space screen information representing the virtual space screen generated in Step S103 (Step S104).

The transmission/reception unit 31 of the terminal apparatus 3 receives the virtual space screen information transmitted from the server 5, and the display control unit 34 of the terminal apparatus 3 causes the display 308 to display the virtual space screen represented by the received virtual space screen information (Step S105).

The reception unit 32 of the terminal apparatus 3 receives a predetermined input operation performed on the displayed virtual space screen and an operation on the three-dimensional shape included in the virtual space screen. The input operation includes an operation of inputting a user ID and usage information.

The transmission/reception unit 31 transmits, to the server 5, the user ID and the usage information that are related to the input operation received by the reception unit 32 and the item information and operation information related to the operation on the three-dimensional shape, and the transmission/reception unit 51 of the server 5 receives the user ID, the usage information, the item information, and the operation information transmitted from the terminal apparatus 3 (Step S106).

The storing/reading unit 59 of the server 5 searches the setting information management DB 5001 using the user ID received in Step S106 as a search key to read attribute information associated with the user ID and searches the virtual space management DB 5006 using the item information, the operation information, and the usage information that are received in Step S106 and the attribute information read from the setting information management DB 5001 as search keys to read recommendation information associated with the item information, the operation information, the usage information, and the attribute information.

The generation unit 56 of the server 5 generates a recommendation information screen including the recommendation information read by the storing/reading unit 59 (Step S107). In some embodiments, in alternative to the virtual space management DB 5006, a recommendation information generation unit and a machine learning model that learns using training date including the item information, the operation information, the usage information, the attribute information, and the recommendation information are included. The machine learning model may include a Large Language Model (LLM). In this case, in Step S107, the recommendation information generation unit generates recommendation information based on the item information, the operation information, and the usage information received in step S106, the attribute information read from the setting information management DB 5001, and the machine learning model, and the generation unit 56 generates a recommendation information screen including the recommendation information generated by the recommendation information generation unit.

The transmission/reception unit 51 transmits to the terminal apparatus 3 recommendation information screen information representing the recommendation information screen generated in Step S107 (Step S108).

The transmission/reception unit 31 of the terminal apparatus 3 receives the recommendation information screen information transmitted from the server 5, and the display control unit 34 of the terminal apparatus 3 causes the display 308 to display the recommendation information screen represented by the received recommendation information screen information (Step S109).

The reception unit 32 of the terminal apparatus 3 receives a user operation performed on the displayed recommendation information screen.

The transmission/reception unit 31 transmits, to the server 5, operation information indicating the operation performed on the recommendation information screen received by the reception unit 32, and the transmission/reception unit 51 of the server 5 receives the operation information transmitted from the terminal apparatus 3 (Step S110).

The storing/reading unit 59 of the server 5 updates the virtual space management table of the virtual space management DB 5006 based on the operation information received in step S110 (Step S111).

The functional units of the server 5 in FIG. 3 may be integrated into the terminal apparatus 3, and the processing of the server 5 described with reference to FIG. 7 is executed by the terminal apparatus 3.

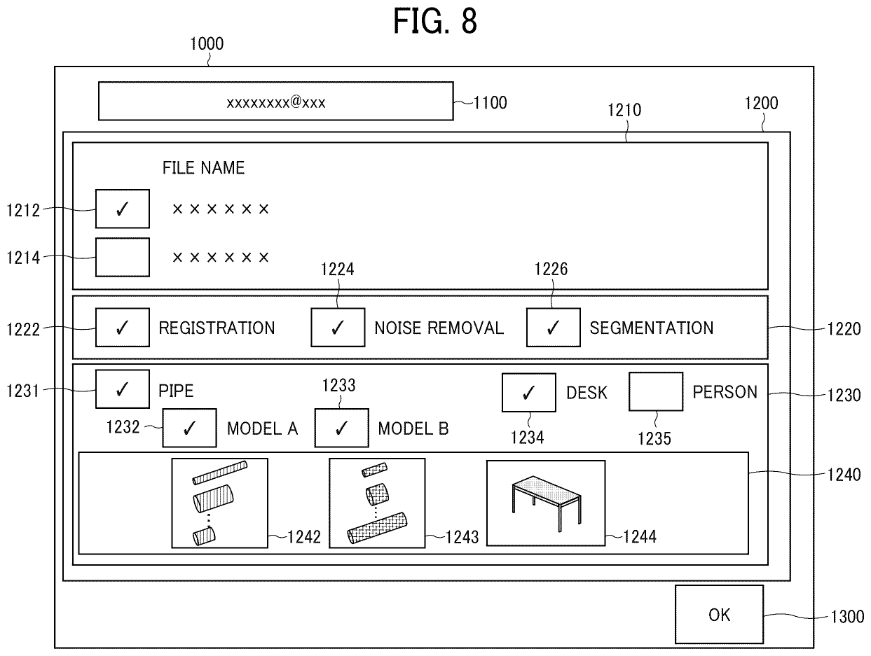

FIG. 8 is a diagram illustrating a display screen according to the present embodiment.

FIG. 8 illustrates a display screen 1000 displayed on the display 308 of the terminal apparatus 3 in Step S5 of the sequence diagram illustrated in FIG. 6.

The display control unit 34 of the terminal apparatus 3 displays, on the display screen 1000, a user information display screen 1100, a setting screen 1200, and a confirmation button 1300 that is an example of an instruction receiving screen.

The setting screen 1200 includes a point cloud setting screen 1210, a processing setting screen 1220, and the model information setting screen (an example of a reception screen) 1230.

The point cloud setting screen 1210 is a screen for receiving a point cloud setting operation for setting point cloud information representing a three-dimensional point cloud to be used for generating three-dimensional shape information, and the display control unit 34 displays point cloud setting boxes 1212 and 1214 in association with the file names of multiple pieces of point cloud data read by the storing/reading unit 59. For the point cloud setting boxes (point cloud setting boxes 1212 and 1214), multiple boxes can be set.

The processing setting screen 1220 is a screen for receiving a processing setting operation for setting a processing program for generating three-dimensional shape information, and the display control unit 34 displays processing setting boxes 1222, 1224, and 1226 in association with the names of multiple types of processing.

In FIG. 8, the processing setting box 1222 is used to set a processing program related to registration, the processing setting box 1224 is used to set a processing program related to noise removal, and the processing setting box 1226 is used to set a processing program related to segmentation. The details of these processing programs will be described later. In the present embodiment, the processing setting box 1222 related to registration may be automatically set when multiple point clouds are set on the point cloud setting screen 1210. Further, the processing related to segmentation is regarded to be invariably executed, and the processing setting box 1226 related to segmentation may be omitted accordingly.

The display control unit 34 displays the processing setting boxes 1222, 1224, and 1226 after initializing the settings for the processing setting boxes 1222, 1224, and 1226 based on the history read by the storing/reading unit 59. If there is no history, predetermined settings are used as the initial settings for the display.

The model information setting screen 1230 is an example of a reception screen for receiving a model setting operation for setting multiple pieces of model shape information to be used for generating three-dimensional shape information from the multiple pieces of model shape information.

The model information setting screen 1230 includes model information setting boxes 1231, 1234, 1235, and 1236, model candidate setting boxes 1232 and 1233, and a model display screen 1240.

The display control unit 34 displays model information setting boxes 1231, 1234, and 1235 in association with the names of multiple pieces of model information, and displays model candidate setting boxes 1232 and 1233 in association with the names of multiple shapes. In the description of the present embodiment, the model information indicates a group of model shape information including one or more pieces of model shape information.

In FIG. 8, the model information setting box 1231 is used to set model information to represent the three-dimensional model shape for a pipe, the model information setting box 1234 is used to set model information to represent the three-dimensional model shape for a desk, and the model information setting box 1235 is used to set model information to represent the three-dimensional model shape for a person.

The model candidate setting box 1232 is used to set model shape information to represent the three-dimensional model shape for a pipe model A, and the model candidate setting box 1233 is used to set model shape information to represent the three-dimensional model shape for a pipe model B.

The display control unit 34 displays on the model display screen 1240 model candidate 1242 or 1243 or a model shape 1244 in association with the name of the set model information or the name of the set model candidate. When the model shape information includes the information on color, the display may include color for the representation. In the present embodiment, the multiple model candidates have three-dimensional model shapes that are different from each other, and are used to generate multiple pieces of three-dimensional shape information from the same area of the three-dimensional point cloud, and one piece of three-dimensional shape information is determined from among the multiple pieces of generated three-dimensional shape information in the subsequent process.

The model candidate 1242 indicates multiple three-dimensional model shapes corresponding to the pipe model A, the model candidate 1243 indicates multiple three-dimensional model shapes corresponding to the pipe model B, and the model shape 1244 indicates the three-dimensional model shape for a desk.

When the reception unit 32 of the terminal apparatus 3 receives an operation of pointing on a setting box performed by a pointing device such as the mouse 312, the display control unit 34 displays a check mark in the setting box, and the reception unit 32 confirms various setting operations in response to receiving the various setting operations and an operation on the confirmation button 1300.

Then, as described in Step S6 of FIG. 6, the transmission/reception unit 31 transmits, to the server 5, input information including various setting information according to the various setting operations received by the reception unit 32.

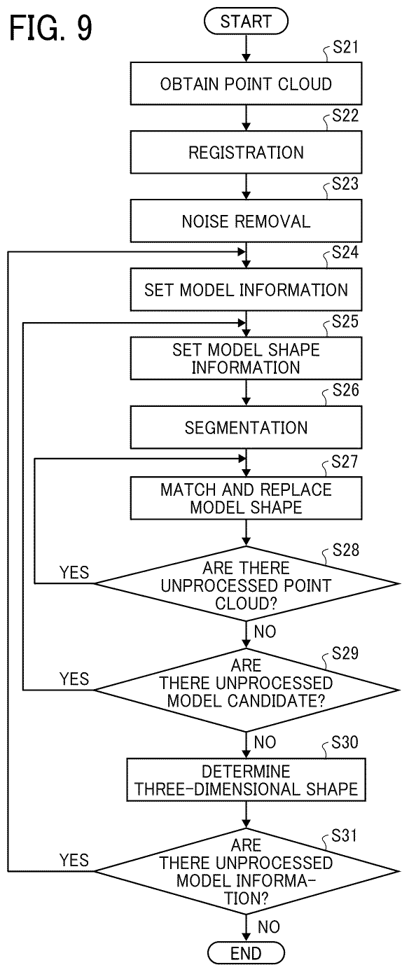

FIG. 9 is a flowchart of a three-dimensional shape generation process according to the present embodiment, and corresponds to the processing of Step S8 in FIG. 6.

The processing unit 53 of the server 5 obtains three-dimensional point cloud data read by the storing/reading unit 59 (Step S21). When multiple pieces of three-dimensional point cloud data are obtained and a processing program read by the storing/reading unit 59 includes a processing program related to registration, the processing unit 53 executes registration processing (step S22). The registration processing is processing for transforming multiple three-dimensional point clouds into a unified and integrated three-dimensional point cloud.

When the processing program read by the storing/reading unit 59 includes a processing program related to noise removal, the processing unit 53 executes noise removal processing (Step S23). The noise removal processing is processing for removing unnecessary a point cloud (points) from the three-dimensional point cloud.

The setting unit 57 of the server 5 sets model information based on the model setting information included in the input information received in Step S6 of FIG. 6 (Step S24). For example, as illustrated in FIG. 8, when the model setting information includes the model information indicating the three-dimensional model shape for a pipe and the model information indicating the three-dimensional model shape for a desk, the setting unit 57 first sets the model information indicating the three-dimensional model shape for a pipe.

The setting unit 57 sets one or more pieces of model shape information based on the model setting information included in the input information received in Step S6 of FIG. 6 (Step S25). For example, as illustrated in FIG. 8, when the model setting information includes model shape information indicating a three-dimensional model shape corresponding to the pipe model A and model shape information indicating a three-dimensional model shape corresponding to the pipe model B, as multiple model candidates, the setting unit 57 first sets the model shape information indicating the three-dimensional model shape corresponding to the pipe model A.

When the processing program read by the storing/reading unit 59 includes a processing program related to segmentation, the processing unit 53 executes segmentation processing (Step S26).

The segmentation processing is also called a point cloud classification processing, and a technique such as machine learning Point Transformer (X.-F. Han, Y.-J. Kuang, and G.-Q. Xiao, “Point cloud learning with transformer,” 2021, arXiv: 2104.13636.) is known.

The segmentation processing is processing for labeling a specific point cloud (points) in the three-dimensional point cloud to distinguish the specific point cloud (points) from other point clouds (points). The multiple specific point clouds may be labeled differently so as to distinguish the multiple specific point clouds from each other. Further, the segmentation processing may be executed in combination with clustering processing for grouping point clouds (points) at a short distance among the labeled point clouds.

The processing unit 53 compares the point cloud labeled in Step S26 to each of the multiple three-dimensional model shapes included in the model shape information set in Step S25, and replaces a specific region with a three-dimensional model shape that has the closest shape (Step S27). When there is no optimum model shape, the processing unit 53 may adjust the size and shape of the model shape. If there is a case that the shape is the same, but the texture information is different, the comparison may be performed with the models including a model having the same shape but different textures. The processing unit 53 may omit the segmentation processing in Step S26 and may execute Step S25 after Step S27.

The determination unit 55 of the server 5 determines whether there is an unprocessed point cloud on which the replacement is not performed (Step S28). When there is a point cloud on which the replacement is not performed, the process returns to step 27, and the processing unit 53 performs the replacement of a specific region using a three-dimensional model shape for unprocessed point cloud. The determination unit 55 may determine that there is no unprocessed point cloud, and processing for the point cloud is completed, when the ratio of the unprocessed point cloud to all the point clouds is equal to or less than a predetermined value.

On the other hand, when there is no unprocessed point cloud, the determination unit 55 determines whether there is an unprocessed model candidate (Step S29). When there is an unprocessed model candidate, the process returns to step 25, and the setting unit 57 sets the model shape information included in the unprocessed model candidate. For example, the setting unit 57 sets, as the multiple model candidates, model shape information indicating the three-dimensional model shape corresponding to the pipe model B, following the model shape information indicating the three-dimensional model shape corresponding to the pipe model A.

When there is no unprocessed model candidate, the processing unit 53 determines three-dimensional shape information based on the shape setting information included in the input information received in Step S11 of FIG. 6 (Step S30). For example, the setting unit 57 determines, as the three-dimensional shape information, one of three-dimensional shape information generated based on the model shape information of the pipe model A as one of the multiple model candidates and three-dimensional shape information generated based on the model shape information of the pipe model B as another one of the multiple model candidates.

The determination unit 55 determines whether unprocessed model information is present (Step S31), and when unprocessed model information is absent, the process ends.

When unprocessed model information is present, the process returns to Step S24, and the setting unit 57 sets the unprocessed model information. For example, the setting unit 57 sets the model information for a desk following the model information for a pipe.

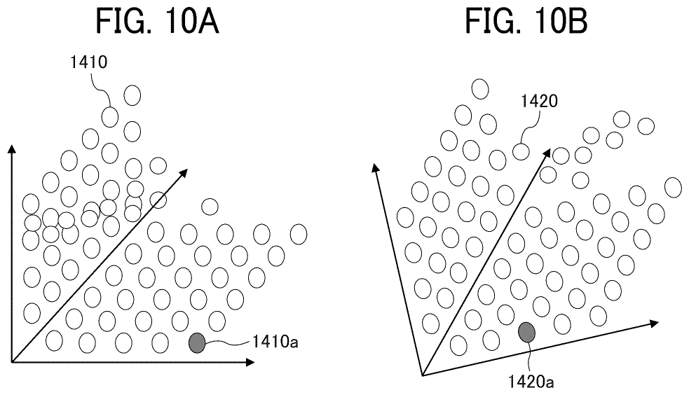

FIGS. 10A and 10B are diagrams illustrating registration processing according to the present embodiment.

In FIG. 10A, a first three-dimensional point cloud 1410 is illustrated, and in FIG. 10B, a second three-dimensional point cloud 1420 is illustrated.

For example, the processing unit 53 converts the first three-dimensional point cloud 1410 and the second three-dimensional point cloud 1420 into one integrated three-dimensional point cloud by aligning a feature point 1410a included in the first three-dimensional point cloud 1410 and a feature point 1420a included in the second three-dimensional point cloud 1420.

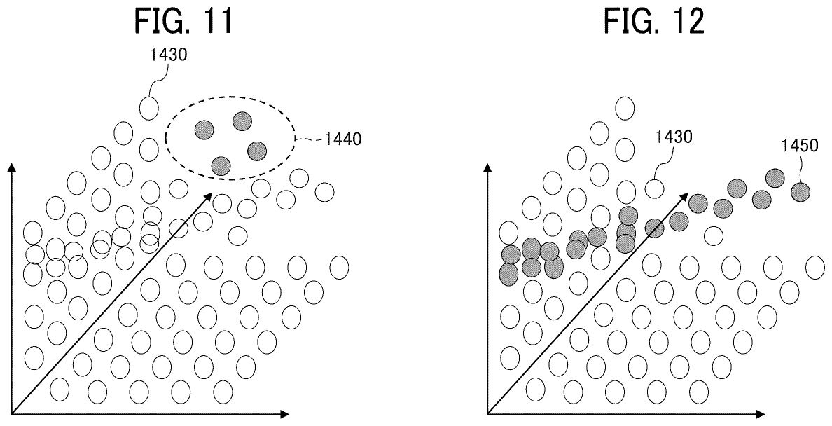

FIG. 11 is a diagram illustrating noise removal processing according to the present embodiment. The processing unit 53 removes an unnecessary point cloud 1440 from a three-dimensional point cloud 1430.

FIG. 12 is a diagram illustrating segmentation processing according to the present embodiment.

The processing unit 53 labels specific points (a specific point cloud) in the three-dimensional point cloud 1430 to form a labeled point cloud 1450 (black points), and the points of labeled point cloud 1450 are identifiable from the other points, accordingly.

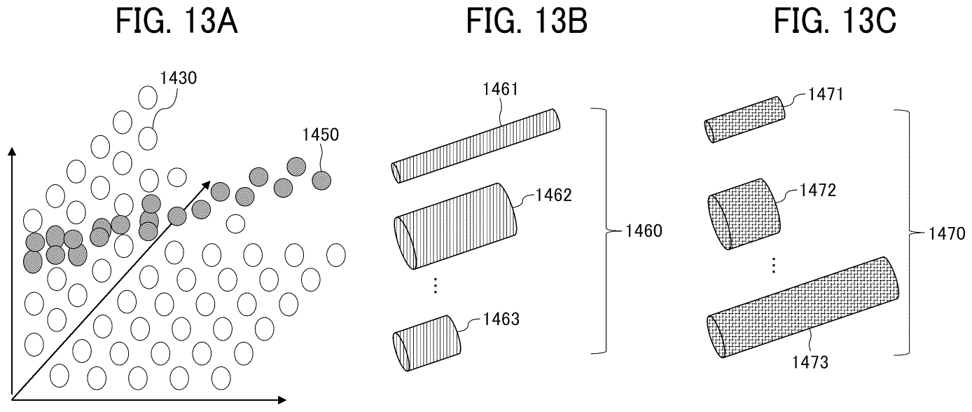

FIGS. 13A to 13C are diagrams illustrating model comparison and replacement processing (model transformation) according to the present embodiment.

In FIG. 13A, the three-dimensional point cloud 1430 is illustrated, in FIG. 13B, a model candidate 1460 for the pipe A is illustrated, and in FIG. 13C, a model candidates 1470 for the pipe B is illustrated.

The model candidate 1460 for the pipe A includes multiple model shapes 1461, 1462, and 1463 having different shapes, and the model candidate 1470 for the pipe B includes multiple model shapes 1471, 1472, and 1473 having different shapes.

The processing unit 53 compares the labeled point cloud 1450 (black points (black point cloud)) to each of the multiple model shapes 1461, 1462, and 1463 for the pipe A, and replaces the specific region using the model shape having the closest shape. When there is no optimum model shape among the plurality of model shapes 1461, 1462, and 1463, the processing unit 53 may adjust the size and shape of the model shape. In the description of the present embodiment, for example, the distance between the model shape and each point of the point cloud is calculated, and the model shape having the smallest sum of the distances is determined as the model shape having the closest shape.

If there is a case that the shape is the same, but the texture or the material is different, the comparison may be performed with multiple textures and multiple materials. For example, the color (RGB) of a point cloud is compared with the color of the texture included in the model shape information, and the closest color is set. Specifically, the closest color is obtained by using, for example, the difference between the color information (RGB) of the texture for a model at the closest position from each point of a point cloud and the RGB value of the point cloud, and the sum of the absolute values is obtained, but the comparison method is not limited.

Further, the processing unit 53 compares the labeled point cloud 1450 (black points (black point cloud)) to each of the multiple model shapes 1471, 1472, and 1473 for the pipe B, and replaces the specific region using the model shape having the closest shape. When there is no optimum model shape, the processing unit 53 may adjust the size and shape of the model shape. When there is no optimum model shape in the multiple model shapes 1471, 1472, and 1473, the processing unit 53 may adjust the size and shape of the model shape.

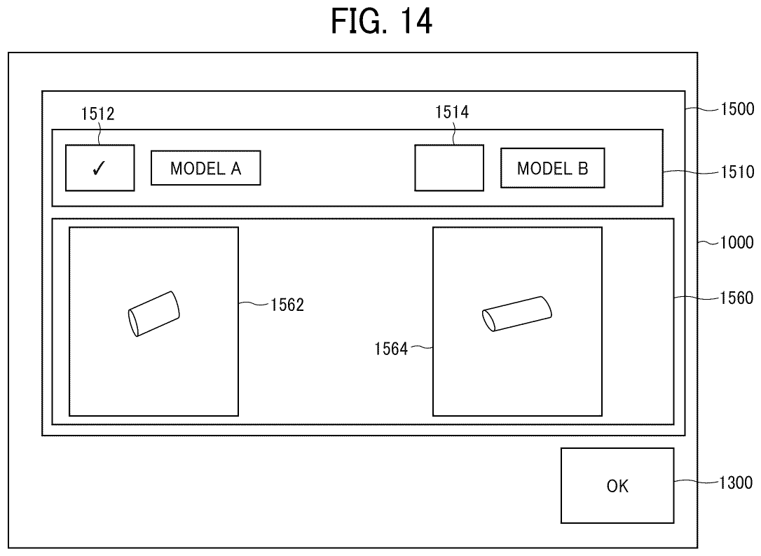

FIG. 14 is a diagram illustrating an operation screen according to the present embodiment.

FIG. 14 illustrates the display screen 1000 displayed on the display 308 of the terminal apparatus 3 in Step S10 of the sequence diagram illustrated in FIG. 6.

The display control unit 34 of the terminal apparatus 3 displays, on the display screen 1000, an operation screen 1500 including a shape generation setting screen 1510 and a generated shape display screen 1560, in addition to the confirmation button 1300.

The shape generation setting screen 1510 is an example of a second reception screen for receiving a shape setting operation for setting one piece of three-dimensional shape information from multiple pieces of three-dimensional shape information, and includes shape generation setting boxes 1512 and 1514.

The shape generation setting box 1512 is used to set a three-dimensional shape generated based on the model shape information of the pipe model A, and the shape generation setting box 1514 is used to set a three-dimensional shape generated based on the model shape information of the pipe model B.

The display control unit 34 displays, on the generated shape display screen 1560, generated shapes 1562 and 1564 in association with the names of multiple pieces of model shape information.

The generated shape 1562 represents a three-dimensional shape generated based on the model shape information of the pipe model A, and the generated shape 1564 indicates a three-dimensional shape generated based on the model shape information of the pipe model B.

When the shape generation setting box 1512 or 1514 is pointed to by a pointing device such as the mouse 312, the reception unit 32 of the terminal apparatus 3 receives the shape setting operation, and when the confirmation button 1300 is operated, the reception unit 32 confirms the shape setting operation.

Then, as described in Step S11 of FIG. 6, the transmission/reception unit 31 transmits, to the server 5, input information including shape setting information by the shape setting operation received by the reception unit 32.

In FIG. 14, one of the generated shape 1562 and the generated shape 1564 is selected based on a user operation. Alternatively, the processing unit 53 of the server 5 may automatically select one closer to the labeled point cloud between the generated shape 1562 and the generated shape 1564 without taking into account the user operation. In the description of the present embodiment, for example, the distance between each of the generated shapes and each point of the point cloud is calculated, and a generated shape having smaller sum of the distances is determined as the generated shape closer to the labeled point cloud.

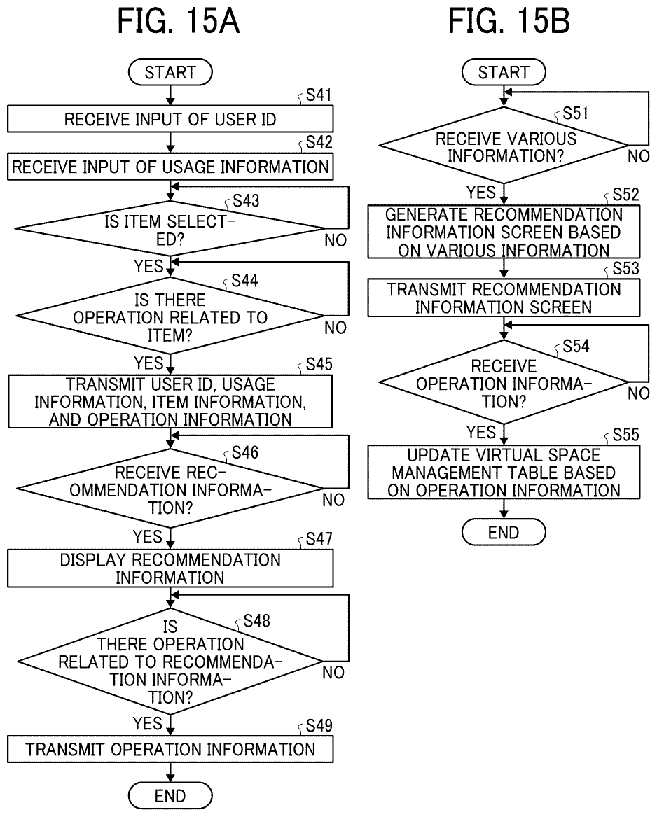

FIG. 15A and FIG. 15B are flowcharts corresponding to a virtual space operation process performed by the terminal apparatus 3 and the server 5, respectively, according to the present embodiment, and the flowcharts correspond to Steps S105 to S111 of the sequence diagram illustrated in FIG. 7.

In FIG. 15A, the reception unit 32 of the terminal apparatus 3 receives an operation of inputting a user ID (Step S41), and receives an operation of inputting usage information (Step S42).

The determination unit 35 determines whether the reception unit 32 has received an operation of selecting an item as a three-dimensional shape included in a virtual space screen displayed on the display 308 (Step S43).

When the item is selected, the determination unit 5 determines whether the reception unit 32 has received a predetermined operation for the selected item (Step S44).

When a predetermined operation on the selected item is received, the transmission/reception unit 31 transmits, to the server 5, item information indicating the selected item and operation information indicating the predetermined operation performed on the selected item in addition to the user ID and the usage information received by the reception unit 32 (Step S45).

The determination unit 35 determines whether the transmission/reception unit 31 has received recommendation information screen information transmitted from the server 5 (Step S46).

When the recommendation information screen information is received, the display control unit 34 causes the display 308 to display a recommendation information screen represented by the received recommendation information screen information. (Step S47).

The determination unit 35 determines whether the reception unit 32 has received a user operation on the displayed recommendation information screen (Step S48). When a user operation is received, the transmission/reception unit 31 transmits, to the server 5, operation information indicating the user operation performed on the recommendation information screen and received by the reception unit 32 (Step S49). For example, the reception unit 32 receives an operation of selecting one recommendation from among multiple recommendations represented by recommendation information.

In FIG. 15B, the determination unit 55 of the server 5 determines whether the transmission/reception unit 51 has received a user ID, usage information, item information, and operation information transmitted from the terminal apparatus 3 (Step S51).

When the determination in Step S51 indicates “YES”, the storing/reading unit 59 of the server 5 searches the setting information management DB 5001 using the user ID received in Step S106 as a search key to read attribute information associated with the user ID and searches the model shape management DB 5005 using the item information, the operation information, and the usage information that are received in Step S106 and the attribute information read from the setting information management DB 5001 as search keys to read recommendation information associated with the item information, the operation information, the usage information, and the attribute information. The generation unit 56 generates a recommendation information screen including the recommendation information read by the storing/reading unit 59 (Step S52).

The transmission/reception unit 51 transmits to the terminal apparatus 3 recommendation information screen information indicating the recommendation information screen generated in Step S52 (Step S53). The determination unit 35 determines whether the transmission/reception unit 51 has received operation information transmitted from the terminal apparatus 3 (Step S54).

When the operation information is received in Step S54, the storing/reading unit 59 updates the virtual space management table of the virtual space management DB 5006 based on the operation information received in Step S54 (Step S55). For example, the storing/reading unit 59 updates the recommendation information stored in the virtual space management DB 5006 from multiple recommendations to a single recommendation that has been selected, based on the operation information indicating an operation of selecting one recommendation from among the multiple recommendations represented by the recommendation information.

In the above description, the intention of the user to whom a recommendation is to be provided may not be reflected in the recommendation information. In other words, since the recommendation is determined and performed based on the operation alone, there may be cases where information desired by the user is not provided to the user as a recommendation.

For example, when the mouse is moved frequently, it is determined that the user is uncertain in making a decision, and useful information for this case may be provided as a recommendation. However, in reality, the frequent mouse movements may indicate that the user is trying to examine a particular object from various angles. Accordingly, if the operation is misinterpreted as described above, the information provided as a recommendation may be noise, or the recommendation itself may be noise.

To cope with this, the reception unit 32 of the terminal apparatus 3 may receive input of text, a document, or voice, in addition to the user ID and the usage information.

In this case, the server 5 can analyze input information representing the input by the user in the system, search for information that is likely to be relevant from an information group given in advance or from a knowledge base extracted by data mining, and provide information that is likely to be relevant to the user as a recommendation.

For example, based on input information indicating “the main pipe is damaged . . . ” , a prediction that the user may want to know whether a crack to be repaired is present, or a prediction that the user may want to know an inquiry destination when a pipe is damaged, may be made, and a solution to the prediction may be provided.

Since the user does not always input information with some intention, the intention can be easily grasped by using the input information. As described above, by adding part of the user's intention as an input, it is easy to provide the user with useful information as a recommendation from among a vast amount of information.

In the description of the present embodiment described above, both the user operation and the information input by the user are used as the trigger, but the operation may not be used in some cases. For example, information to be provided as a recommendation may be selected from among a vast amount of information for a certain point by using the input information alone. The user operation has the role of a first narrowing function to narrow down the vast amount of information.

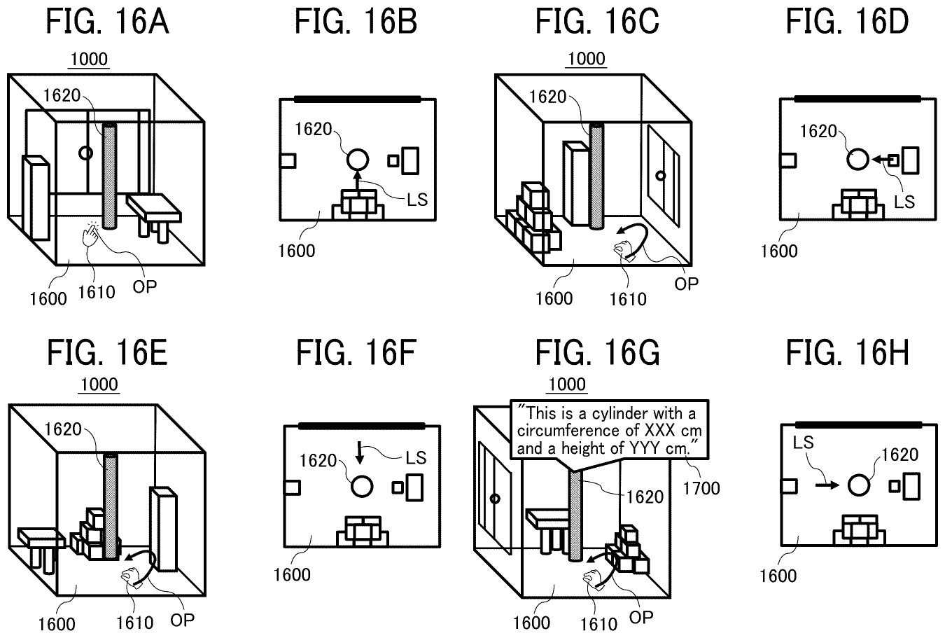

FIGS. 16A to 16H are diagrams each illustrating a virtual space screen according to the present embodiment.

Each of FIGS. 16A, 16C, and 16E illustrates the display screen 1000 displayed on the display 308 of the terminal apparatus 3 in Step S105 of the sequence diagram illustrated in FIG. 7, and FIGS. 16B, 16D, and 16F are top views of FIGS. 16A, 16C, and 16E, respectively.

FIG. 16G illustrates the display screen 1000 displayed on the display 308 of the terminal apparatus 3 in Step S109 of the sequence diagram illustrated in FIG. 7, and FIG. 16H illustrates a top view of FIG. 16G.

In FIG. 16A, the display control unit 34 of the terminal apparatus 3 displays, on the display screen 1000, a virtual space screen 1600 that includes a cylinder 1620 that is an example of an item including a three-dimensional shape and is viewed from a viewpoint LS.

When the user performs an operation OP of selecting the cylinder 1620 with a pointer 1610, the reception unit 32 receives the selection of the cylinder 1620, and the user starts the operation OP on the cylinder 1620 with the pointer 1610.

As illustrated in FIG. 16C, when the user performs a rotation operation OP for the cylinder 1620 with the pointer 1610, the reception unit 32 receives the rotation operation OP, and the display control unit 34 displays the virtual space screen 1600 in which the viewpoint LS is changed according to the rotation operation OP on the display screen 1000 as illustrated in FIG. 16D.

As illustrated in FIG. 16E, when the user continues the rotation operation OP for the cylinder 1620 with the pointer 1610, the reception unit 32 receives the rotation operation OP, and the display control unit 34 displays the virtual space screen 1600 in which the viewpoint LS is further changed according to the rotation operation OP on the display screen 1000 as illustrated in FIG. 16F.

As illustrated in FIG. 16G, when the user further continues the rotation operation OP for the cylinder 1620 with the pointer 1610, the reception unit 32 receives the rotation operation OP.

Then, as described in Step S45 of FIG. 15, the transmission/reception unit 31 transmits, to the server 5, the item information indicating the cylinder and the operation information indicating the rotation operation of circling around the cylinder along with the user ID and the usage information.

Then, as described in Step S46 of FIG. 15, when the transmission/reception unit 31 receives the recommendation information screen information transmitted from the server 5, the display control unit 34 displays the recommendation information screen 1700 including the recommendation information on the display screen 1000 so as to be superimposed on the virtual space screen 1600.

In FIG. 16G, as described in Step S52 of FIG. 15, the storing/reading unit 59 of the server 5 reads, from the model shape management DB 5005, measurement information for the cylinder 1620 as recommendation information that indicates a comment of “This is a cylinder with a circumference of XXX cm and a height of YYY cm.” and is associated with the item information for a cylinder, the operation information indicating a rotation operation for a cylinder, the usage information, and the attribute information associated with the user ID. Then, the display control unit 34 displays a recommendation information screen 1700 including the recommendation information on the display screen 1000.

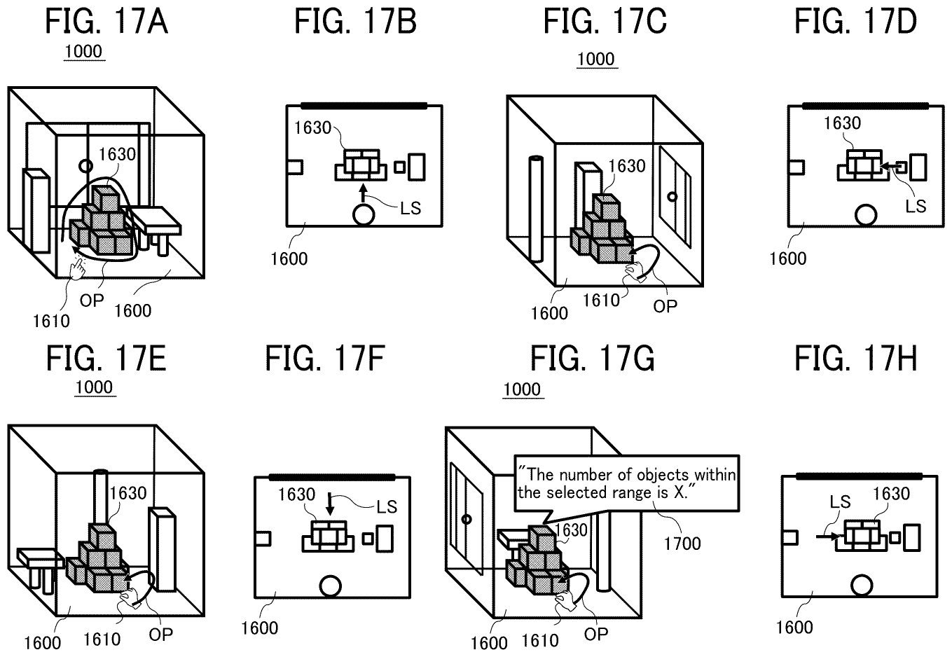

FIGS. 17A to 17H are diagrams each illustrating a virtual space screen according to the present embodiment.

Similar to FIGS. 16A to 16F, each of FIGS. 17A, 17C, and 17E illustrates the display screen 1000 displayed on the display 308 of the terminal apparatus 3 in Step S105 of the sequence diagram illustrated in FIG. 7, and FIGS. 17B, 17D, and 17F are top views of FIGS. 17A, 17C, and 17E, respectively.

FIG. 17G illustrates the display screen 1000 displayed on the display 308 of the terminal apparatus 3 in Step S109 of the sequence diagram illustrated in FIG. 7, and FIG. 17H illustrates a top view of FIG. 17G.

In FIG. 17A, the display control unit 34 of the terminal apparatus 3 displays, on the display screen 1000, the virtual space screen 1600 that includes multiple cardboard boxes 1630 that are an example of an item including a three-dimensional shape and is viewed from the viewpoint LS.

When the user performs an operation of circling the multiple cardboard boxes 1630 with a pointer 1610, the reception unit 32 receives the selection of the multiple cardboard boxes 1630, and the user starts an operation OP on the multiple cardboard boxes 1630 with the pointer 1610.

As illustrated in FIG. 17C, when the user performs a rotation operation OP for the multiple cardboard boxes 1630 with the pointer 1610, the reception unit 32 receives the rotation operation OP, and the display control unit 34 displays the virtual space screen 1600 in which the viewpoint LS is changed according to the rotation operation OP on the display screen 1000 as illustrated in FIG. 17D.

As illustrated in FIG. 17E, when the user continues to perform the rotation operation OP for the multiple cardboard boxes 1630 with the pointer 1610, the reception unit 32 receives the rotation operation OP, and the display control unit 34 displays the virtual space screen 1600 in which the viewpoint LS is further changed according to the rotation operation OP on the display screen 1000 as illustrated in FIG. 17F.

As illustrated in FIG. 17G, when the user further continues the rotation operation OP for the multiple cardboard boxes 1630 with the pointer 1610, the reception unit 32 receives the rotation operation OP.

Then, as described in Step S45 of FIG. 15, the transmission/reception unit 31 transmits, to the server 5, the item information indicating the multiple cardboard boxes and the operation information indicating the rotation operation of circling around the multiple cardboard boxes along with the user ID and the usage information.

Then, as described in Step S46 of FIG. 15, when the transmission/reception unit 31 receives the recommendation information screen information transmitted from the server 5, the display control unit 34 displays the recommendation information screen 1700 including the recommendation information on the display screen 1000 so as to be superimposed on the virtual space screen 1600.

In FIG. 17G, as described in Step S52 of FIG. 15, the storing/reading unit 59 of the server 5 reads, from the model shape management DB 5005, measurement information for the multiple cardboard boxes 1630 as recommendation information that indicates a comment of “The number of objects within the selected range is X.” and is associated with the item information indicating the multiple cardboard boxes, the operation information indicating the rotation operation for the multiple cardboard boxes, the usage information, and the attribute information associated with the user ID. Then, the display control unit 34 displays, on the display screen 1000, a recommendation information screen 1700 including the recommendation information.

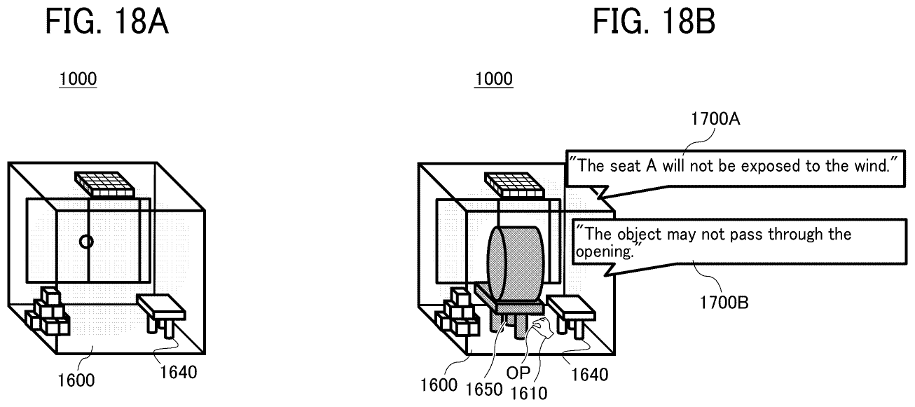

FIGS. 18A and 18B are diagrams each illustrating still a virtual space screen according to the present embodiment.

FIG. 18A illustrates the display screen 1000 displayed on the display 308 of the terminal apparatus 3 in Step S105 of the sequence diagram illustrated in FIG. 7. FIG. 18B illustrates the display screen 1000 displayed on the display 308 of the terminal apparatus 3 in Step S109 of the sequence diagram illustrated in FIG. 7.

In FIG. 18A, the display control unit 34 of the terminal apparatus 3 displays, on the display screen 1000, the virtual space screen 1600 including a floor 1640 that is an example of an item including a three-dimensional shape.

As illustrated in FIG. 18B, when the user performs an operation OP of arranging a machine 1650 that is an example of an item including a three-dimensional shape on the floor 1640 with the pointer 1610, the reception unit 32 receives the operation OP of arranging the machine 1650 on the floor 1640.

Then, as described in Step S45 of FIG. 15, the transmission/reception unit 31 transmits, to the server 5, item information indicating the floor 1640 and operation information indicating the operation of arranging the machine 1650 on the floor 1640 along with the user ID and the usage information.

Then, as described in Step S46 of FIG. 15, when the transmission/reception unit 31 receives the recommendation information screen information transmitted from the server 5, the display control unit 34 displays the recommendation information screen 1700 including the recommendation information on the display screen 1000 so as to be superimposed on the virtual space screen 1600.

In FIG. 18B, as described in Step S52 of FIG. 15, the storing/reading unit 59 of the server 5 reads, from the model shape management DB 5005, multiple comments of “The seat A will not be exposed to the wind.” and “The object may not pass through the opening.” as recommendation information that is associated with the item information indicating the floor, the operation information indicating the operation of arranging the machine on the floor, the usage information, and the attribute information associated with the user ID. Then, the display control unit 34 displays, on the display screen 1000, recommendation information screens 1700A and 1700B each of which includes the recommendation information.

Then, as described in the flowchart of FIG. 15, when the reception unit 32 receives an operation of selecting, for example, the recommendation information screen 1700A from the recommendation information screens 1700A and 1700B, the transmission/reception unit 31 transmits, to the server 5, operation information indicating the operation of selecting the recommendation information screen 1700A.

When the transmission/reception unit 51 of the server 5 receives the operation information transmitted from the terminal apparatus 3, for example, the storing/reading unit 59 updates the recommendation information stored in the virtual space management DB 5006 from multiple recommendations to a single recommendation that is indicated in the recommendation information screen 1700A, based on the received operation information.

When multiple recommendations are displayed as illustrated in FIG. 18B, information selected by the user may be recorded and stored in the knowledge base by introducing a mechanism for learning the information.

As a result, the contents of interest are preferentially recommended for each user, and the preference of the user can be learned.

For example, even if the attribute information illustrated in FIGS. 5A and 5B is not stored and managed, information related to cost and safety can be easily provided as a recommendation to a site supervisor, to easily provide a recommended work procedure to a site worker, and to easily provide information related to an inspection point as a recommendation to a maintenance manager.

The learning/recommendation may be performed for each user, or may be performed for, for example, each group to which the user belongs. Further, similar information may be provided as a recommendation to users for each generation or gender by using the personal information of the users.

As a method of collecting information on the user's preference, a mechanism of providing the information in a format of question and answer (Q&A) to prompt the user to select information by clicking can be used. For example, in an alternative to presenting a comment of “It is dangerous . . . ” , a comment of “There is a concern about safety in . . . Do you want to display . . . ? ” may be displayed as a recommendation method.

In the former case, it is assumed that the information is closed without being selected after the information is presented, but in the latter case, the user clicks to know the contents, and at the same time, the selection log can be collected on the system, so that the preference of the user can be learned without the user being aware.

Further, the recommended item can be preferentially given in accordance with the learned preference of the user. As a preferential presentation method, a method of excluding information with low priority from a presentation target may be used. Further, the importance of information may be made visually distinguishable by, for example, making information with high priority bold or increasing the font size, such as a word cloud. In the case of the word cloud, easy-to-understand text may be displayed, and when the user selects predetermined text, detailed information may be viewable. Further, a method of hierarchically confirming the data as in a tree diagram or a list display may be used.

The server 5 including a learning unit can record the recommendation information selected by the user. The preference is learned by associating the selection information with other related information such as the attribute information or a task included in the usage information. With this learning, information predicted to be highly relevant can be provided as a recommendation to the same person or users having the same attribute.

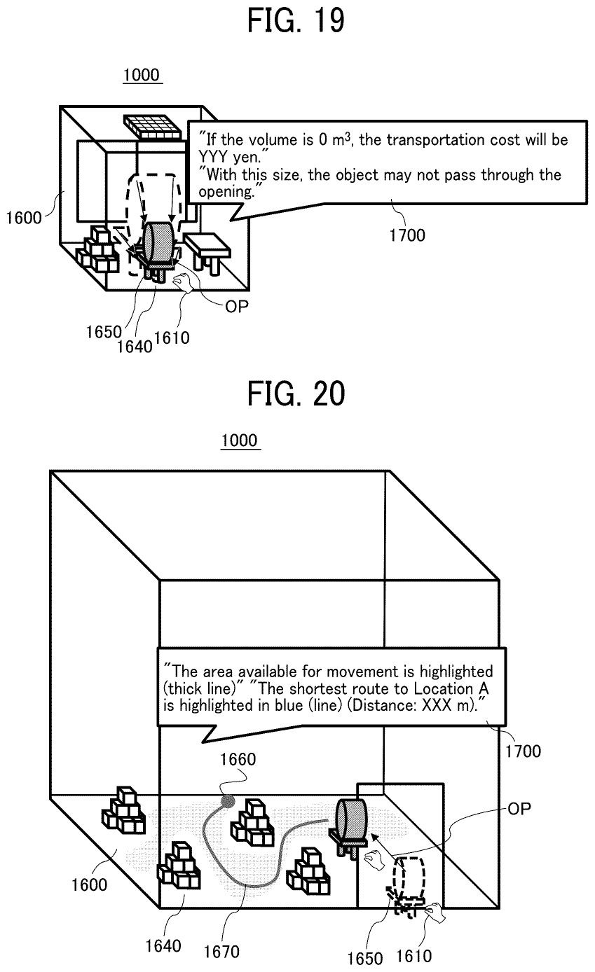

FIG. 19 is a diagram illustrating a virtual space screen according to the present embodiment.

FIG. 19 illustrates the display screen 1000 displayed on the display 308 of the terminal apparatus 3 in Step S109 of the sequence diagram illustrated in FIG. 7.

In FIG. 19, the display control unit 34 of the terminal apparatus 3 displays, on the display screen 1000, the virtual space screen 1600 including the floor 1640 that is an example of an item including a three-dimensional shape.

When the user performs, with the pointer 1610, an operation OP of arranging the machine 1650 that is an example of an item including a three-dimensional shape on the floor 1640 and changing the size of the machine 1650, the reception unit 32 receives the operation OP of arranging the machine 1650 on the floor 1640 and changing the size of the machine 1650.

Then, as described in Step S45 of FIG. 15, the transmission/reception unit 31 transmits, to the server 5, item information indicating the floor 1640 and operation information indicating the operation of arranging the machine 1650 on the floor 1640 and changing the size of the machine 1650 along with the user ID and the usage information.

Then, as described in Step S46 of FIG. 15, when the transmission/reception unit 31 receives the recommendation information screen information transmitted from the server 5, the display control unit 34 displays the recommendation information screen 1700 including the recommendation information on the display screen 1000 so as to be superimposed on the virtual space screen 1600.

As described in Step S52 of FIG. 15, the storing/reading unit 59 of the server 5 reads, from the model shape management DB 5005, comments of “If the volume is 0 m3, the transportation cost will be YYY yen” and “With this size, the object may not pass through the opening.” as recommendation information that is associated with the item information indicating the floor, the operation information indicating the operation of arranging the machine on the floor and change the size, and the usage information, and that is associated with the user ID corresponding to the attribute information. Then, the display control unit 34 displays, on the display screen 1000, the recommendation information screen 1700 that includes the recommendation information.

FIG. 20 is a diagram illustrating a virtual space screen according to the present embodiment.

In FIG. 20, the display control unit 34 of the terminal apparatus 3 displays, on the display screen 1000, the virtual space screen 1600 including the floor 1640 and the machine 1650 each of which is an example of an item including a three-dimensional shape.

When the user performs an operation OP of moving the machine 1650 on the floor 1640 with the pointer 1610, the reception unit 32 receives the operation OP of selecting the machine 1650 and moving the machine 1650.

Then, as described in Step S45 of FIG. 15, the transmission/reception unit 31 transmits, to the server 5, item information indicating the machine 1650 and operation information indicating the operation of moving the machine 1650 along with the user ID and the usage information.

Then, as described in Step S46 of FIG. 15, when the transmission/reception unit 31 receives the recommendation information screen information transmitted from the server 5, the display control unit 34 displays recommendation information screens 1660, 1670, and 1700 including the recommendation information on the display screen 1000 so as to be superimposed on the virtual space screen 1600.

As described in Step S52 of FIG. 15, the storing/reading unit 59 of the server 5 reads, from the model shape management DB 5005, comments of “The area available for movement is highlighted (tick line).” and “The shortest route to Location A is highlighted in blue (line) (Distance: XXX m).” as recommendation information that is associated with the item information indicating the machine, the operation information indicating the operation of moving the machine, and the usage information, and that is associated with the user ID corresponding to the attribute information. Then, the display control unit 34 displays, on the display screen 1000, the recommendation information screens 1660, 1670, and 1700 that include the recommendation information.

### Aspect 1

As described above, the terminal apparatus 3 that is an example of an input and output apparatus according to an embodiment includes the display control unit 34 to display a three-dimensional shape on the display 308 that is an example of a display unit and the reception unit 32 to receive an operation on the three-dimensional shape displayed on the display 308. The display control unit 34 further displays the recommendation information 1700 that is an example of specific information corresponding to a specific three-dimensional shape and a specific operation performed on the display 308 based on the specific operation performed on the specific three-dimensional shape displayed on the display 308.

Accordingly, the recommendation information 1700 corresponding to the specific three-dimensional shape and the specific operation can be provided to the user.

### Aspect 2

In Aspect 1, the display control unit 34 displays, on the display 308, first information corresponding to a first three-dimensional shape and a first operation based on the first operation on the first three-dimensional shape displayed on the display 308. Further, the display control unit 34 displays, on the display 308, second information corresponding to the first three-dimensional shape and a second operation based on the second operation performed on the first three-dimensional shape displayed on the display 308.

Accordingly, information to be provided to the user for the same three-dimensional shape can vary for each operation.

### Aspect 3

In Aspect 1, the display control unit 34 displays, on the display 308, first information corresponding to a first three-dimensional shape and a first operation based on the first operation on the first three-dimensional shape displayed on the display 308. Further, the display control unit 34 displays, on the display 308, second information corresponding to a second three-dimensional shape and a first operation based on the first operation performed on the second three-dimensional shape displayed on the display 308.

Accordingly, information to be provided to the user for the same operation can vary for each three-dimensional shape.

### Aspect 4

In Aspect 1, the display control unit 34 displays, on the display 308, first information corresponding to a first three-dimensional shape and a first operation based on the first operation on the first three-dimensional shape displayed on the display 308. Further, the display control unit 34 displays, on the display 308, second information corresponding to a second three-dimensional shape and a second operation based on the second operation performed on the second three-dimensional shape displayed on the display 308.

Accordingly, when both the shape and operation are different, different information can be provided to the user. In other words, different information can be provided to the user for each combination of the three-dimensional shape and the operation.

### Aspect 5

In Aspect 1, when a specific condition is satisfied based on a specific operation on a specific three-dimensional shape displayed on the display 308, the display control unit 34 causes the display 308 to display the recommendation information 1700 corresponding to the specific three-dimensional shape, the specific operation, and the specific condition.

Accordingly, the recommendation information 1700 corresponding to the specific three-dimensional shape, the specific operation, and the specific condition can be provided to the user.

### Aspect 6

In Aspect 1, when a first condition is satisfied, the display control unit 34 causes the display 308 to display, based on the first operation on the first three-dimensional shape displayed on the display 308, first information corresponding to a first three-dimensional shape, a first operation, and a first condition. When a second condition is satisfied, the display control unit 34 causes the display 308 to display, based on the first operation on the first three-dimensional shape displayed on the display 308, second information corresponding to the first three-dimensional shape, the first operation, and the second condition.

Accordingly, information to be provided to the user for the same three-dimensional shape and the same operation can vary for condition.

### Aspect 7

In Aspect 6, the reception unit 32 further receives input of predetermined input information, and the first condition and the second condition are conditions related to the input information.

Accordingly, information to be provided to the user for the same three-dimensional shape and the same operation can vary for each condition related to input information such as text, document, and voice.

### Aspect 8

In Aspect 7, the input information includes user information for identifying a user or usage information for identifying a usage scenario in which a three-dimensional shape displayed on the display 308 is used, and the first condition and the second condition are conditions related to the user information or the usage information.

Accordingly, information to be provided to the user for the same three-dimensional shape and the same operation can vary for each condition related to the user information or the usage information.

### Aspect 9

In Aspect 8, the first condition and the second condition are conditions related to a user attribute, a time of year or a task using the three-dimensional shape.

Accordingly, information to be provided to the user for the same three-dimensional shape and the same operation can vary for each user attribute, time of year, or task related to the usage of the three-dimensional shape.

### Aspect 10

In any one of Aspect 1 to Aspect 9, the operation includes an operation identified by three-dimensional coordinates.

Accordingly, the recommendation information 1700 corresponding to a specific three-dimensional shape and a specific three-dimensional operation can be provided to the user.

### Aspect 11

In any one of Aspect 1 to Aspect 10, the reception unit 32 further receives an instruction operation for instructing generation of three-dimensional shape information representing a three-dimensional shape based on point cloud information representing a three-dimensional point cloud, and the display control unit 34 causes the display 308 to display the three-dimensional shape related to the three-dimensional shape information generated based on the point cloud information.

Accordingly, the three-dimensional shape generated based on the three-dimensional point cloud can be displayed, and the recommendation information 1700 corresponding to the specific three-dimensional shape and the specific three-dimensional operation can be provided to the user.

### Aspect 12

The server 5 that is an example of an information processing apparatus according to an embodiment includes the transmission/reception unit 51 that is an example of a transmission unit that transmits, to the terminal apparatus 3, display screen information representing a display screen for displaying a three-dimensional shape. The transmission/reception unit 51 receives, from the terminal apparatus 3, input information indicating that a specific operation is performed on a specific three-dimensional shape displayed on the display screen, and transmits specific information corresponding to the specific three-dimensional shape and the specific operation based on the input information.

Accordingly, the recommendation information 1700 corresponding to the specific three-dimensional shape and the specific operation can be provided to the user of the terminal apparatus 3.

### Aspect 13

An information processing method executed by the terminal apparatus 3 as an example of the information processing apparatus according to an embodiment includes a first display step of displaying a three-dimensional shape on the display 308, a reception step of receiving an operation on the three-dimensional shape displayed on the display 308, and a second display step of displaying specific information corresponding to the specific three-dimensional shape and the specific operation on the display 308 based on the specific operation on the specific three-dimensional shape displayed on the display 308.

### Aspect 14

A program according to an embodiment causes a computer to execute a first display step of displaying a three-dimensional shape on the display 308, a reception step of receiving an operation on the three-dimensional shape displayed on the display 308, and a second display step of displaying specific information corresponding to a specific three-dimensional shape and a specific operation on the display 308 based on the specific operation on the specific three-dimensional shape displayed on the display 308.

### Aspect 15

The three-dimensional shape processing system 1 as an example of an information processing system according to an embodiment includes the terminal apparatus 3 and the server 5 connected to the terminal apparatus 3 via the network 100. The terminal apparatus 3 includes the display control unit 34 to display a three-dimensional shape on the display 308, a reception unit 32 to receive an operation on the three-dimensional shape displayed on the display 308, and the transmission/reception unit 31 to transmit, to the server 5, input information indicating that a specific operation on a specific three-dimensional shape displayed on the display 308 has been performed. The server 5 includes the transmission/reception unit 51 to receive the input information transmitted from the terminal apparatus 3 and transmit specific information corresponding to the specific three-dimensional shape and the specific operation to the terminal apparatus 3 based on the input information. The transmission/reception unit 31 receives the specific information transmitted from the server 5, and the display control unit 34 displays the specific information on the display 308.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The present invention can be implemented in any convenient form, for example using dedicated hardware, or a mixture of dedicated hardware and software. The present invention may be implemented as computer software implemented by one or more networked processing apparatuses. The processing apparatuses include any suitably programmed apparatuses such as a general purpose computer, a personal digital assistant, a Wireless Application Protocol (WAP) or third-generation (3G)-compliant mobile telephone, and so on. Since the present invention can be implemented as software, each and every aspect of the present invention thus encompasses computer software implementable on a programmable device. The computer software can be provided to the programmable device using any conventional carrier medium (carrier means). The carrier medium includes a transient carrier medium such as an electrical, optical, microwave, acoustic or radio frequency signal carrying the computer code. An example of such a transient medium is a Transmission Control Protocol/Internet Protocol (TCP/IP) signal carrying computer code over an IP network, such as the Internet. The carrier medium may also include a storage medium for storing processor readable code such as a floppy disk, a hard disk, a compact disc read-only memory (CD-ROM), a magnetic tape device, or a solid state memory device.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

This patent application is based on and claims priority to Japanese Patent Application No. 2023-100172, filed on Jun. 19, 2023, in the Japan Patent Office, the entire disclosure of which is hereby incorporated by reference herein.

### REFERENCE SIGNS LIST

1 three-dimensional shape processing system
100 communication network
3 terminal apparatus
31 transmission/reception unit
32 reception unit
34 display control unit
36 determination unit
39 storing/reading unit.
308 display
3000 storage unit
5 server
51 transmission/reception unit
53 processing unit
55 determination unit
56 generation unit
57 setting unit
59 storing/reading unit
5000 storage unit
5001 setting information management DB
5002 storage processing management DB
5003 point cloud management DB
5004 three-dimensional shape management DB
5005 model shape management DB
5006 virtual space management DB
1000: display screen
1100: user information display screen
1200: setting screen
1210 point cloud setting screen
1212, 1214 point cloud setting box
1220 processing setting screen
1222, 1224, 1226 processing setting box
1230 model information setting screen
1231, 1234, 1235 model information setting box
1232, 1233 model candidate setting box
1240 model display screen
1242, 1243 model candidate
1244 model shape
1300 confirmation button
1410 first three-dimensional point cloud
1420 second three-dimensional point cloud
1430 three-dimensional point cloud
1440 unnecessary point cloud
1450 labeled point cloud
1460, 1470 model candidate
1461, 1462, 1463, 1471, 1472, 1473 model shape
1500 operation screen
1510 shape generation setting screen
1512, 1514 shape generation setting box
1560 generated shape display screen
1562, 1564 generated shape
1600 virtual space screen
1610 pointer
1620 three-dimensional shape (cylinder)
1630 three-dimensional shape (multiple cardboard boxes)
1640 three-dimensional shape (floor)
1650 three-dimensional shape (machine)
1660 recommendation information (route)
1670 recommendation information (destination)
1700 recommendation information
OP operation
LS viewpoint

1. An input and output apparatus comprising:
a display control circuitry configured to display a three-dimensional shape on a display; and
a receiver configured to receive an operation on the three-dimensional shape displayed on the display, wherein
the display control circuitry is further configured to display, on the display, information corresponding to the three-dimensional shape and the operation based on the operation performed on the three-dimensional shape.

2. The input and output apparatus of claim 1, wherein the operation includes a first operation and a second operation that are different from each other,
the information includes first information and second information that are different from each other, and
the display control circuitry is further configured to:
display, on the display, the first information corresponding to the three-dimensional shape and the first operation based on the first operation on the three-dimensional shape; and
display, on the display, the second information corresponding to the three-dimensional shape and the second operation based on the second operation on the three-dimensional shape.

3. The input and output apparatus of claim 1, wherein
the three-dimensional shape includes a first three-dimensional shape and a second three-dimensional shape that are different from each other,
the information includes first information and second information that are different from each other, and
the display control circuitry is further configured to:
display, on the display, the first information corresponding to the first three-dimensional shape and the operation based on the operation on the first three-dimensional shape; and
display, on the display, the second information corresponding to the second three-dimensional shape and the operation based on the operation on the second three-dimensional shape.

4. The input and output apparatus of claim 1, wherein
the three-dimensional shape includes a first three-dimensional shape and a second three-dimensional shape that are different from each other,
the operation includes a first operation and a second operation that are different from each other,
the information includes first information and second information that are different from each other, and
the display control circuitry is further configured to:
display, on the display, the first information corresponding to the first three-dimensional shape and the first operation based on the first operation on the first three-dimensional shape; and
display, on the display, the second information corresponding to the second three-dimensional shape and the second operation based on the second operation on the second three-dimensional shape.

5. The input and output apparatus of claim 1, wherein,
in response to a specific condition being satisfied, the display control circuitry is further configured to display, on the display, the information corresponding to the three-dimensional shape, the operation, and the specific condition based on the operation on the three-dimensional shape.

6. The input and output apparatus of claim 5, wherein
the information includes first information and second information that are different from each other,
the specific condition includes a first condition and a second condition that are different from each other, and
in response to the first condition being satisfied, the display control circuitry is further configured to display, on the display, the first information corresponding to the three-dimensional shape, the operation, and the first condition based on the operation on the three-dimensional shape, and
in response to the second condition being satisfied, the display control circuitry is further configured to display, on the display, the second information corresponding to the three-dimensional shape, the operation, and the second condition based on the operation on the three-dimensional shape.

7. The input and output apparatus of claim 6, wherein
receiver is further configured to receive input information, and
each of the first condition and the second condition is a condition related to the input information.

8. The input and output apparatus of claim 7, wherein
the input information includes one of user information or a usage information, the user information identifying a user, the usage information identifying a usage scenario in which the three-dimensional shape displayed on the display is used, and
each of the first condition and the second condition is a condition related to the one of the user information or the usage information.

9. The input and output apparatus of claim 8, wherein
each of the first condition and the second condition is a condition related to one of a user attribute, a time of year to use the three-dimensional shape, or a task using the three-dimensional shape.

10. The input and output apparatus of claim 1, wherein
the operation includes an operation identified by three-dimensional coordinates.

11. The input and output apparatus of claim 1, wherein
the receiver is further configured to receive an instruction operation for instructing to generate three-dimensional shape information representing the three-dimensional shape based on point cloud information representing a three-dimensional point cloud, and
the display control circuitry is further configured to display, on the display, the three-dimensional shape according to the three-dimensional shape information generated based on the point cloud information.

12. An information processing apparatus, comprising:
a transmitter configured to transmit, to an input and output apparatus, display screen information representing a display screen for displaying a three-dimensional shape; and
a receiver configured to receive input information transmitted from the input and output apparatus, the input information indicating that an operation has been performed on the three-dimensional shape displayed on the display screen, wherein
the transmitter is further configured to transmit, to the input and output apparatus, information corresponding to the three-dimensional shape and the operation based on the input information.

13. (canceled)

14. A non-transitory recording medium storing computer-readable code for controlling a computer system to carry out a method, the method including:
displaying a three-dimensional shape on a display;
receiving an operation on the three-dimensional shape displayed on the display; and
displaying information corresponding to the three-dimensional shape and the operation based on the operation on the three-dimensional shape displayed on the display.

15. An information processing system, comprising:
the input and output apparatus of claim 1; and
an information processing apparatus connected to the input and output apparatus via a network,
wherein the input and output apparatus further includes:
a transmitter configured to transmit, to the information processing apparatus, input information indicating that the operation has been performed on the three-dimensional shape displayed on the display,
wherein the information processing apparatus includes:
a second receiver configured to receive the input information transmitted from the input and output apparatus; and
a second transmitter configured to transmit, to the input and output apparatus, information corresponding to the three-dimensional shape and the operation based on the input information,
wherein the receiver is configured to receive the information transmitted from the information processing apparatus, and
wherein the display control circuitry is further configured to display the information on the display.
